(19) United States
(12) Patent Application Publication
(10) Pub. No.: US 2024/0286913 A1
(43) Pub. Date: Aug. 29, 2024

(54) LITHIUM RECOVERY FROM WASTE GLASS USING ACID LEACHING OR BASE LEACHING

(71) Applicant: CORNING INCORPORATED, CORNING, NY (US)

(72) Inventors: Bavani Balakrisnan, Corning, NY (US); Deqiu Fan, Painted Post, NY (US); Qiang Fu, Painted Post, NY (US); Yuhui Jin, Painted Post, NY (US); Grace MaryAlice Yu Leahy, Corning, NY (US); Cedrick Alexander O’Shaughnessy, Painted Post, NY (US)

(21) Appl. No.: 18/443,962

(22) Filed: Feb. 16, 2024

Related U.S. Application Data
(60) Provisional application No. 63/447,416, filed on Feb. 22, 2023.

(51) Int. Cl. C01D 15/08; B09B 3/35; B09B 3/70; B09B 3/80; B09B 101/50; C01F 7/76

(52) U.S. Cl. CPC C01D 15/08; B09B 3/35; B09B 3/70; B09B 3/80; C01F 7/76; B09B 2101/50

(57) ABSTRACT

Methods of recovering lithium from glass include crushing the glass to produce glass particles and contacting the glass particles with an aqueous leaching solution at a leaching temperature greater than ambient temperature and less than the boiling temperature of the aqueous leaching solution to produce a leachate slurry. The glass particles include lithium. The aqueous leaching solution includes sulfuric acid in water or sodium hydroxide in water. Contacting the glass particles with the aqueous leaching solution leaches greater than or equal to about 50% of the lithium out of the glass particles. The methods further comprise separating the leachate slurry to produce a solid residue and a leachate, the leachate comprising the lithium leached from the glass particles. The method further include recovering the lithium from the leachate through precipitation.

This application claims the benefit of priority under 35 U.S.C. § 119 of U.S. Provisional Application Ser. No. 63/447,416 filed on Feb. 22, 2023, the content of which is relied upon and incorporated herein by reference in its entirety.

### BACKGROUND

### Field

The present specification generally relates to glass and glass manufacturing, and particularly to methods of recovering lithium from waste glass.

### Technical Background

Lithium presents the highest sublimation energy, electronegativity, and ionization energy and the smallest ionic radius of the alkali group metals, which makes lithium a desirable option for the cathode material for rechargeable high-power-density batteries. After batteries, the glass and ceramic industries are the second largest consumers of lithium. The addition of lithium in ceramics lowers the firing temperatures and thermal expansion and increases the strength of ceramic bodies. In lithium-containing glasses, the highly mobile lithium atoms offer high-ion-diffusivity, which enables the glass to be chemically strengthened through ion-exchange. This chemical strengthening process can provide good drop performance and mechanical properties to the glass.

### SUMMARY

A first aspect of the present disclosure may be directed to a method of recovering lithium from glass. The method may comprise crushing the glass to produce glass particles, which comprise lithium. The method may further comprise contacting the glass particles with an aqueous leaching solution at a leaching temperature greater than ambient temperature and less than the boiling temperature of the aqueous leaching solution to produce a leachate slurry. The aqueous leaching solution may comprise sulfuric acid in water or sodium hydroxide in water. Contacting the glass particles with the aqueous leaching solution may leach greater than or equal to about 50% of the lithium out of the glass particles. The method may further comprise separating the leachate slurry to produce a solid residue and a leachate, the leachate comprising the lithium leached from the glass particles, and recovering the lithium from the leachate.

A second aspect of the present disclosure may include the first aspect wherein the aqueous leaching solution may comprise sulfuric acid (H₂SO₄) in water.

A third aspect of the present disclosure may include the second aspect, wherein the aqueous leaching solution may comprise from about 1 wt. % to about 90 wt. % H₂SO₄ based on the total weight of the aqueous leaching solution before contacting the glass particles with the aqueous leaching solution.

A fourth aspect of the present disclosure may include either one of the second or third aspects, wherein the aqueous leaching solution may comprise from about 10 wt. % to about 20 wt. % H₂SO₄ based on the total weight of the aqueous leaching solution before contacting the glass particles with the aqueous leaching solution.

A fifth aspect of the present disclosure may include the first aspect, wherein the aqueous leaching solution may comprise from about 10 wt. % to about 70 wt. % of a base, which may be selected from sodium hydroxide (NaOH), potassium hydroxide (KOH), or combinations thereof.

A sixth aspect of the present disclosure may include the fifth aspect, wherein the aqueous leaching solution may further comprise from about 5 wt. % to about 20 wt. % calcium oxide (CaO) based on the total weight of the aqueous leaching solution.

A seventh aspect of the present disclosure may include either one of the fifth or sixth aspects, wherein the aqueous leaching solution may comprise from about 10 wt. % to about 70 wt. % sodium hydroxide based on the total weight of the aqueous leaching solution before contacting the glass particles with the aqueous leaching solution.

An eighth aspect of the present disclosure may include any one of the first through seventh aspects, wherein the leaching temperature may be from about 55° C. to about 95° C.

A ninth aspect of the present disclosure may include any one of the first through eighth aspects, comprising contacting the glass particles with the aqueous leaching solution at a weight ratio of liquid to solid of greater than or equal to about 3.

A tenth aspect of the present disclosure may include any one of the first through ninth aspects, wherein the glass of the glass particles may comprise from about 30 mol % to about 85 mol % SiO₂, from about 2 mol % to about 30 mol % Al₂O₃, from 0 mol % to about 20 mol % B₂O₃, from about 2 mol % to about 20 mol % Li₂O, from 0 mol % to about 20 mol % Na₂O, from 0 mol % to about 20 mol % K₂O, from 0 mol % to about 20 mol % MgO, from 0 mol % to about 20 mol % CaO, from 0 mol % to about 10 mol % SrO, from 0 mol % to about 10 mol % BaO, from 0 mol % to about 5 mol % ZrO₂, from 0 mol % to about 5 mol % Ti₂O, and from 0 mol % to about 5 mol % Sn₂O.

An eleventh aspect of the present disclosure may include any one of the first through tenth aspects, wherein the glass particles may comprise an amorphous structure having less than or equal to about 5 wt. %, or even less than or equal to 1 wt. % crystallinity based on the total weight of the glass.

A twelfth aspect of the present disclosure may include any one of the first through eleventh aspects, wherein the glass particles may have an average particle size of from about 2 micrometers (μm) to about 1 mm.

A thirteenth aspect of the present disclosure may include any one of the first through twelfth aspects, wherein the method may have an extraction efficiency of greater than or equal to about 70%, greater than or equal to about 80%, or even greater than or equal to about 85% for extracting lithium from the glass particles.

A fourteenth aspect of the present disclosure may include any one of the first through thirteenth aspects, wherein the solid residue may have a lithium content that is less than about 30%, less than about 20%, or even less than about 15% of a lithium content of the glass particles prior to contacting with the aqueous leaching solution.

A fifteenth aspect of the present disclosure may include any one of the first through fourteenth aspects, wherein recovering the lithium from the leachate may comprise precipitating one or more lithium salts from the leachate and filtering the lithium salts from the leachate.

A sixteenth aspect of the present disclosure may include the fifteenth aspect, wherein precipitating the one or more lithium salts from the leachate may comprise contacting the leachate with a precipitating agent comprising sodium carbonate, sodium phosphate, or both, wherein the precipitating agent may react with the lithium in the leachate to produce the one or more lithium salts.

A seventeenth aspect of the present disclosure may include the sixteenth aspect, wherein the precipitating agent may comprise sodium phosphate and the lithium salts may comprise lithium phosphate, lithium sodium phosphate, or combinations thereof.

An eighteenth aspect of the present disclosure may include the sixteenth aspect, wherein the precipitating agent may comprise sodium carbonate, the one or more lithium salts may comprise lithium carbonate, and precipitating the one or more lithium salts from the leachate further may comprise: evaporating water from the leachate until a concentration of lithium in the leachate is greater than or equal to about 20 g/L; and after evaporating the water, contacting the leachate with the sodium carbonate.

A nineteenth aspect of the present disclosure may include the eighteenth aspect, further comprising filtering precipitated solids from the leachate after evaporating the water and before contacting with the sodium carbonate.

A twentieth aspect of the present disclosure may include any one of the fifteenth through nineteenth aspects, wherein recovering the lithium from the leachate may further comprise removing aluminum from the leachate; after removing the aluminum from the leachate, precipitating the one or more lithium salts from the leachate; and separating the one or more lithium salts from the leachate to produce a lithium depleted filtrate and the one or more lithium salts.

A twenty-first aspect of the present disclosure may include the twentieth aspect, wherein removing aluminum from the leachate may comprise: precipitating one or more aluminum compounds from the leachate; and filtering the one or more aluminum compounds from the leachate to produce a reduced aluminum filtrate.

A twenty-second aspect of the present disclosure may include the twenty-first aspect, wherein precipitating the one or more aluminum compounds may comprise neutralizing the leachate to a pH in a range of from about 6 to about 7, wherein neutralizing the leachate may precipitate aluminum species, iron species, or both from the leachate.

A twenty-third aspect of the present disclosure may include the twenty-second aspect, wherein neutralizing the leachate to a pH in a range of from about 6 to about 7 may comprise adding one or more of calcium carbonate, calcium oxide, calcium hydroxide, sodium hydroxide, sodium carbonate, or combinations thereof to the leachate.

A twenty-fourth aspect of the present disclosure may include either one of the twenty-second or twenty-third aspects, wherein the glass particles may comprise less than about 5 mol % calcium compounds based on the total moles of glass, and neutralizing the leachate may comprise adding a base consisting of NaOH to the leachate, wherein adding NaOH may produce the first precipitated solid comprising highly pure aluminum hydroxide.

A twenty-fifth aspect of the present disclosure may include the twenty-fourth aspect, further comprising using the highly pure aluminum hydroxide as an alumina precursor in a glass or glass ceramic manufacturing process.

A twenty-sixth aspect of the present disclosure may include either one of the twenty-fourth or twenty-fifth aspects, wherein calcium species are not added to the leachate in the step of neutralizing the leachate to a pH of from 6 to 7.

A twenty-seventh aspect of the present disclosure may include either one of the twenty-second or twenty-third aspects, wherein the glass particles may comprise greater than or equal to about 5 mol % calcium compounds based on the total weight of glass.

A twenty-eighth aspect of the present disclosure may include the twenty-seventh aspect, wherein the neutralizing the leachate may comprise adding one or more of calcium carbonate, calcium oxide, calcium hydroxide, sodium hydroxide, sodium carbonate, or combinations thereof to the leachate.

A twenty-ninth aspect of the present disclosure may include either one of the twenty-seventh or twenty-eighth aspects, comprising recycling the first precipitated solids to an aluminum process.

A thirtieth aspect of the present disclosure may include any one of the twentieth through twenty-ninth aspects, wherein the aqueous leaching solution may be an acid leaching solution and removing aluminum from the leachate may comprise: contacting the leachate with a sulfate reagent, wherein the sulfate reagent may react with the at least a portion of the aluminum in the leachate to produce alum; crystallizing the alum in the leachate; and separating the alum from the leachate to produce a reduced aluminum filtrate and alum solids.

A thirty-first aspect of the present disclosure may include the thirtieth aspect, further comprising: precipitating aluminum solids from the reduced aluminum filtrate to produce an aluminum precipitation effluent; and separating the aluminum precipitation effluent to produce an aluminum depleted filtrate and aluminum containing solids.

A thirty-second aspect of the present disclosure may include any one of the first through thirty-first aspects, wherein the aqueous leaching solution may be an acid leaching solution and recovering the lithium from the leachate may further comprise removing alkaline earth metals from the leachate after removing the aluminum from the leachate and before precipitating the one or more lithium salts.

A thirty-third aspect of the present disclosure may include the thirty-second aspect, wherein removing alkaline earth metals from the leachate may comprise: increasing the pH of the leachate to a pH range of from about 12 to about 13 by adding lime, calcium carbonate, sodium hydroxide, or combinations of these to the leachate, wherein increasing the pH into the range of about 12 to about 13 may cause precipitation of alkaline earth containing precipitants from the leachate; and filtering the alkaline earth containing precipitant from the leachate.

A thirty-fourth aspect of the present disclosure may include any one of the first through thirty-third aspects, further comprising removing boron from the leachate.

A thirty-fifth aspect of the present disclosure may include the thirty fourth aspect, wherein removing boron from the leachate may comprise extracting boron from the leachate with iso-octyl alcohol.

A thirty-sixth aspect of the present disclosure may include any one of the first through thirty-fifth aspects, further comprising purifying the lithium salts by washing with hot water.

A thirty-seventh aspect of the present disclosure may include any one of the first through thirty-sixth aspects, further comprising: after separating the one or more lithium salts from the leachate, adding sulfuric acid to the lithium depleted filtrate to produce a sodium sulfate solution, wherein the sulfuric acid may react with hydroxide and carbonate ions in the lithium-depleted second filtrate to produce sodium sulfate, carbon dioxide, and water; cooling the sodium sulfate solution, wherein the cooling may crystallize sodium sulfate; separating the crystallized sodium sulfate from the cooled sodium sulfate solution to produce sodium sulfate solids and a crystallization mother liquor; and recovering residual lithium ions from the crystallization mother liquor.

A thirty-eighth aspect of the present disclosure may include the thirty-seventh aspect, wherein recovering residual lithium ions from the crystallization mother liquor may comprise adding sodium carbonate, sodium phosphate, or both to the crystallization mother liquor to precipitate lithium carbonate, lithium phosphate, or both and separating the lithium carbonate, lithium phosphate, or both from the crystallization mother liquor.

A thirty-ninth aspect of the present disclosure may include the thirty-eighth aspect, further comprising recycling the crystallization mother liquor back to the lithium depleted filtrate prior to adding the sulfuric acid to the lithium-depleted second filtrate.

These and other aspects, advantages, and salient features will become apparent from the following detailed description, the accompanying drawings, and the appended claims.

### BRIEF DESCRIPTION OF THE DRAWINGS

FIG. 1 depicts a flow chart for a method of recovering lithium from waste glass through acid leaching, according to embodiments shown and described herein;

FIG. 2 depicts a flow chart for a method of recovering lithium from waste glass through base leaching, according to embodiments shown and described herein;

FIG. 3 depicts a flow chart for a method of separating lithium species from a leachate resulting from the method of FIG. 1, according to embodiments shown and described herein;

FIG. 4 depicts a flow chart for another method of separating lithium species from a leachate resulting from the method of FIG. 1, according to embodiments shown and described herein;

FIG. 5 depicts a flow chart for still another method of separating lithium species from a leachate resulting from the method of FIG. 1, according to embodiments shown and described herein;

FIG. 6 depicts a flow chart for a method of separating lithium species from a leachate resulting from the method of FIG. 2, according to embodiments shown and described herein;

FIG. 7 depicts a flow chart for another method of separating lithium species from a leachate resulting from the method of FIG. 2, according to embodiments shown and described herein;

FIG. 8 graphically depicts a particle size distribution for waste glass particles after crushing, according to embodiments shown and described herein;

FIG. 9 graphically depicts lithium (Li) extraction efficiency (y-axis) as a function of time (x-axis) for acid leaching waste glass at different concentrations of acid in the leaching solution, according to embodiments shown and described herein;

FIG. 10 graphically depicts Li extraction efficiency (y-axis) as a function of liquid to solid mass ratio (L/S) for acid leaching waste glass, according to embodiments shown and described herein;

FIG. 11 graphically depicts Li extraction efficiency (y-axis) as a function of temperature (x-axis) for acid leaching of waste glass, according to embodiments shown and described herein;

FIG. 12 graphically depicts an X-ray diffraction (XRD) plot for residual glass following acid leaching, according to embodiments shown and described herein;

FIG. 13 graphically depicts an XRD plot for aluminum containing solids resulting from neutralizing a leachate from acid leaching with calcium carbonate powder, according to embodiments shown and described herein;

FIG. 14 graphically depicts an XRD plot for second precipitated solids resulting from neutralizing the leachate with calcium carbonate, removing the first precipitated solids, and then adjusting the pH to greater than 12 using calcium carbonate powder, according to embodiments shown and described herein;

FIG. 15 graphically depicts an XRD plot for a lithium precipitate obtained from precipitating the lithium from the leachate using sodium carbonate, according to embodiments shown and described herein;

FIG. 16 graphically depicts an XRD plot for a lithium precipitate obtained from precipitating the lithium using sodium phosphate, according to embodiments shown and described herein; and

FIG. 17 graphically depicts an XRD plot for second precipitated solids resulting from neutralizing the leachate with calcium carbonate, removing the first precipitated solids, and then adjusting the pH to greater than 12 using a 30 wt. % NaOH solution, according to embodiments shown and described herein.

### DETAILED DESCRIPTION

Reference will now be made in detail to embodiments of method of recovering lithium from waste glass, glass ceramics, or both, various embodiments of which will be described herein with specific reference to the accompanying drawings. Whenever possible, the same reference numerals will be used throughout the drawings to refer to the same or like parts. In the following detailed description, numerous specific details may be set forth in order to provide a thorough understanding of embodiments described herein. However, it will be clear to one skilled in the art when embodiments may be practiced without some or all of these specific details. In other instances, well-known features or processes may not be described in detail so as not to unnecessarily obscure the disclosure. In addition, like or identical reference numerals may be used to identify common or similar elements. Moreover, unless otherwise defined, all technical and scientific terms used herein have the same meaning as commonly understood by one of ordinary skill in the art to which this disclosure belongs. In case of conflict, the present specification, including the definitions herein, will control.

Although other methods and materials can be used in the practice or testing of the embodiments, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. More specifically, the example composition ranges given herein are considered part of the specification and further, are considered to provide example numerical range endpoints, equivalent in all respects to their specific inclusion in the text, and all combinations are specifically contemplated and disclosed. Further, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the disclosure be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

It is noted that one or more of the claims may utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

As a result of the raw materials and/or equipment used to produce the glass or glass ceramic compositions discussed herein, certain impurities or components that are not intentionally added, can be present in the final glass or glass ceramic composition. Such materials are present in the glass or glass ceramic composition in minor amounts and are referred to herein as “tramp materials.”

As used herein, a glass or glass ceramic composition having 0 mol % or 0 wt. % of a compound is defined as meaning that the compound, molecule, or element was not purposefully added to the composition, but the composition may still comprise the compound, typically in tramp or trace amounts. Similarly, “iron-free,” “sodium-free,” “lithium-free,” “zirconium-free,” “alkali earth metal-free,” “heavy metal-free” or the like are defined to mean that the compound, molecule, or element was not purposefully added to the composition, but the composition may still comprise iron, sodium, lithium, zirconium, alkali earth metals, or heavy metals, etc., but in approximately tramp or trace amounts.

As used herein, the term “glass ceramic” refers to solids prepared by controlled crystallization of a precursor glass and have one or more crystalline phases and a residual glass phase.

The crystalline phase assemblages and weight percentages of crystalline phases and residual glass phases are determined based on x-ray diffraction (XRD) using a Rietveld analysis. The XRD spectra were obtained using a D8 ENDEAVOR™ XRD machine available from Bruker and equipped with Cu radiation and a LynxEye detector. The Rietveld analysis based on the XRD spectra were performed using the TOPASM version 6 analysis software from Bruker.

The compositions of glass, residual solids, or other materials disclosed herein can be determined through inductively coupled plasma mass spectrometry (ICP-MS). The ICP-MS equipment is used per standard operating procedures and daily calibration standards (CAL-19-368).

The lithium content of various materials, such as any of the various treatment solutions or filtrates disclosed herein, can be determined using ion chromatography (IC) according to known methods.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Directional terms as used herein—for example up, down, right, left, front, back, top, bottom, vertical, horizontal—are made only with reference to the figures as drawn and are not intended to imply absolute orientation unless otherwise expressly stated.

Any ranges used herein include all ranges and subranges and any values there between unless explicitly stated otherwise.

As previously discussed, lithium is used by the glass and glass ceramic industries, which are the second largest consumers of lithium. During the last few years, the demand for lithium use in batteries has been increasing dramatically due to the trend of more and more electric vehicles on the market. It is projected that the total number of electric vehicles is expected to exceed 30 million by 2025. Today, most of the lithium is produced from brine, sea water, or minerals, or by recycling of spent lithium-ion batteries. The production rate of lithium has been straining due to the rising demand for lithium. As a result of this, the lithium price has been increasing significantly. Given the large amount of lithium used in glass manufacturing, there is a strong demand to recycle lithium, especially from wasted glasses, for further utilization.

Waste glass (also called cullet in glass industry) can be generated almost in every step of glass processing for making commercial glass. The current practice for cullet recycling is to re-melt the cullet as much as possible if the cullet itself is compositionally stable without contaminations from other sources. However, often cullet can be contaminated, such as with other glass compositions or other compounds, or the cullet may not have a stable composition. For instance, transition between two different types of glass is a very common thing in production. But the chemical composition of the cullet generated during the transition lies between the starting and end glass and is not chemically stable. Thus, re-melting such cullet as a batch raw material to produce new glass can be very challenging. Further, during the glass finishing stage, cutting fluid and polishing powders are usually used as coolant and polishing agents (such as cerium oxide). Thus, cullet generated from this stage can contain large amounts of organic and inorganic contaminations, which makes re-melting of such cullet directly very difficult or almost impossible. Other times, mixing of cullet with different compositions in a production environment due to poor cullet management can also make reuse very difficult. In the post-customer stage, re-melting the lithium-containing cover and back glasses from retired cell phones directly into making new glasses seems almost impossible at this moment due to poor sorting and contaminations. Today, cullet like this would most likely end up in landfill sites.

Therefore, an ongoing need exists for methods of recovering lithium from waste glass, waste ceramics, or both so that the lithium can be reused in the glass making process. The present disclosure is directed to processes for recovering lithium from waste glass, waste ceramics, or both by using acid leaching or base leaching to extract lithium ions from waste glass fines into an aqueous solution, followed by purification of the lithium containing solution and precipitation of lithium into lithium carbonate or lithium phosphate.

Leaching the lithium out of the glass with an acid or a base can be conducted at temperatures of less than 100° C., such as about 90° C., and more than 90% of extraction efficiency of the lithium can be achieved within an hour. The strategy of acid or base leaching demonstrates wide applicability in recycling lithium containing glasses, which is more tolerable to any level of possible contamination. Though other elements like Al, B, Mg, and Ca may also be extracted into the leachate during the leaching process, the purification techniques can separate these elements from the leachate. The processes disclosed herein can be seamlessly integrated into the commercial spodumene/lepidolite extraction process. Compared with the traditional lithium extraction from minerals, there is no need for the high temperature phase transformation and roasting, therefore, the energy consumption and cost of operation can be significantly lower. High purity lithium carbonate produced from this process can be reused in making new glasses or batteries. The alkaline depleted cullet can potentially be recycled as construction materials (like concrete and brick manufacturing). Aluminum and boron leached out during the acid leaching process can be potentially precipitated or extracted as Al(OH)₃ and HBO₃ by-products. Therefore, most of the aluminum and boron can also be recycled in the process of lithium recycling.

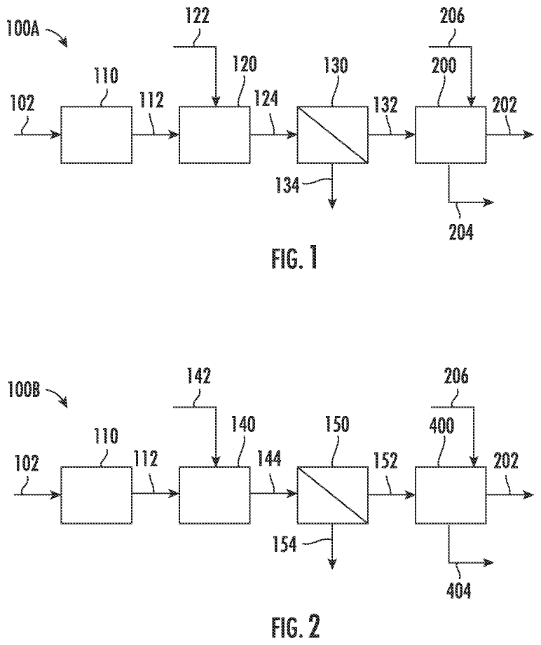

Referring now to FIGS. 1 and 2, the methods 100A, 100B disclosed herein for recovering lithium from waste glass 102 may include crushing the waste glass 102 to produce glass particles 112, wherein the glass particles 112 may comprise lithium. The waste glass 102 may be subjected to a crushing process 110 to crush the glass 102 to produce the glass particles 112. The methods 100A, 100B further include passing the glass particles 112 to a leaching process 120, 140, which includes contacting the glass particles 112 with an aqueous leaching solution 122, 142 at a leaching temperature greater than ambient temperature and less than the boiling temperature of the aqueous leaching solution to produce a leachate slurry. The aqueous leaching solution 122, 142 may be an acid leaching solution 122 or a basic leaching solution 142. The methods 100A, 100B, may comprise separating the leachate slurry 124, 144 to produce a solid residue 134, 154 and a leachate (e.g., acid leachate 132 or basic leachate 152), the leachate comprising lithium ions leached from the glass particles 112. The methods 100A, 100B may further include recovering the lithium ions from the leachate in a lithium separation process 200, 400 to produce the recovered lithium in form of lithium salts 202, 402.

The waste glass 102 may include glass compositions that contain lithium. The waste glass 102 may include glass cullet from the glass manufacturing process, recycled glass, or other glass sources. The waste glass may be made from any glass composition or combinations of glass compositions comprising lithium, such as glass compositions comprising lithium oxide. In embodiments, the glass composition of the waste glass may include at least silica (SiO₂), alumina (Al₂O₃), and lithium oxide (LiO₂). The glass compositions may also include boron trioxide (B₂O₃), zirconia (ZrO₂), alkali metal oxides (e.g., Na₂O, K₂O, etc.), alkaline metal oxides (e.g., MgO, CaO, SrO, BaO), titanium dioxide (TiO₂), tin oxide (SnO₂), or combinations thereof. By way of example and not limitation, in embodiments, the waste glass may comprise one or a plurality of different glass compositions, where the glass compositions may comprise from 30 mol % to 85 mol % SiO₂, from 2 mol % to 30 mol % Al₂O₃, from 0 mol % to 20 mol % B₂O₃, from 2 mol % to 20 mol % LiO₂, from 0 mol % to 20 mol % Na₂O, from 0 mol % to 20 mol % K₂O, from 0 mol % to 20 mol % MgO, from 0 mol % to 20 mol % CaO, from 0 mol % to 10 mol % SrO, from 0 mol % to 10 mol % BaO, from 0 mol % to 5 mol % ZrO₂, from 0 mol % to 5 mol % Ti₂O, and from 0 mol % to 5 mol % Sn₂O. The waste glass 102 may have a generally amorphous glass structure. In embodiments, the waste glass 102 may have less than 5%, or even less than 1% crystalline structures. Due to difficulties in segregating glass, in some instances, the waste glass 102 may comprise some portion of glass that does not have lithium. However, generally, the majority of the waste glass 102 comprises glass compositions that include lithium.

Referring again to FIG. 1, the waste glass 102 may be passed first to a crushing process 110, which may be operable to crush the waste glass 102 to produce glass particles 112. The crushing process 110 may produce glass particles 112 having a median particle size d50 of from about 2 microns (μm) to about 1 mm. In embodiments, the glass particles 112 may have a median particle size d50 of from about 2 μm to about 0.5 mm, from about 2 μm to about 0.3 mm, from about 2 μm to about 100 μm, from about 2 μm to about 50 μm, from about 10 μm to about 1 mm, from about 10 μm to about 0.5 mm, from about 10 μm to about 0.3 mm, from about 10 μm to about 100 μm, from about 10 μm to about 50 μm, from about 15 μm to about 1 mm, from about 15 μm to about 0.5 mm, from about 15 μm to about 0.3 mm, from about 15 μm to about 100 μm, or from about 15 μm to about 50 μm.

Referring to FIG. 1, in embodiments, the glass particles 112 may be passed to an acid leaching process 120. In the acid leaching process 120, the glass particles 112 may be contacted with an acid leaching solution 122 comprising an acid in water. Contact of the glass particles 112 with the acid leaching solution 122 may cause extraction of lithium and other constituents from the glass particles 112 into the acid leaching solution 122 to produce an acid leachate slurry 124 comprising a liquid phase enriched with lithium and the residual solids, which are depleted of lithium. The leachate slurry 124 may then be separated in a solids removal process 130 to produce the acid leachate 132 and the residual solids 134. The acid leachate 132 may then be passed to a lithium recovery process 200 for recovery of the lithium from the acid leachate 132.

The acid leaching solution 122 may comprise sulfuric acid (H₂SO₄) in water. The acid leaching solution 122 may have a concentration of sulfuric acid sufficient to provide a high extraction rate that is sufficient to extract at least 80% of the lithium from the glass particles 112 in a leaching duration of less than 3 hours. In embodiments, the acid leaching solution 122 may have a concentration of sulfuric acid of greater than or equal to about 10 wt. %, greater than or equal to about 12 wt. %, greater than or equal to about 15 wt. %, or even greater than or equal to about 20 wt. % based on the total weight of the acid leaching solution 122 prior to contact with the glass particles 112. When the concentration of sulfuric acid is less than about 10 wt. %, the leaching rate of the acid leaching solution may be too low. In embodiments, the acid leaching solution 122 may have a concentration of sulfuric acid less than about 40 wt. %, less than or equal to about 30 wt. %, or even less than or equal to about 20 wt. %. Increasing the concentration of sulfuric acid may increase the cost of extracting the lithium from the glass particles 112, such as by requiring additional amounts of calcium carbonate and/or sodium hydroxide to neutralize the acid leaching solution to precipitate out extracted species other than lithium, such as aluminum, calcium, and magnesium. In embodiments, the acid leaching solution 122 may comprise from about 1 wt. % to about 90 wt. %, from about 1 wt. % to about 50 wt. %, from about 1 wt. % to about 40 wt. %, from about 1 wt. % to about 30 wt. %, from about 1 wt. % to about 20 wt. %, from about 5 wt. % to about 90 wt. %, from about 5 wt. % to about 50 wt. %, from about 5 wt. % to about 40 wt. %, from about 5 wt. % to about 30 wt. %, from about 5 wt. % to about 20 wt. %, from about 10 wt. % to about 90 wt. %, from about 10 wt. % to about 50 wt. %, from about 10 wt. % to about 40 wt. %, from about 10 wt. % to about 30 wt. %, from about 10 wt. % to about 20 wt. %, from about 12 wt. % to about 40 wt. %, from about 12 wt. % to about 30 wt. %, from about 12 wt. % to about 20 wt. %, from about 15 wt. % to about 40 wt. %, from about 15 wt. % to about 30 wt. %, or from about 15 wt. % to about 20 wt. % sulfuric acid based on the total weight of the acid leaching solution 122 before contacting with the glass particles 112. In embodiments, the acid leaching solution 122 may comprise about 10 wt. % sulfuric acid based on the total weight of the acid leaching solution. In embodiments, the acid leaching solution 122 may comprise about 20 wt. % sulfuric acid based on the total weight of the acid leaching solution.

The acid leaching process 120 may be conducted in a vessel in which the glass particles 112 are contacted with the acid leaching solution 122. In embodiments, the acid leaching process 120 may include mixing the glass particles 112 and the acid leaching solution 122 throughout the leaching duration. The acid leaching process 120 may include contacting the glass particles 112 with the acid leaching solution 122 at a temperature of from about 25° C. to less than 100° C., such as at a temperature of from about 25° C. to about 98° C., from about 25° C. to about 95° C., from about 50° C. to less than 100° C., from about 50° C. to about 98° C. from about 50° C. to about 95° C., from about 55° C. to less than 100° C., from about 55° C. to about 95° C., from about 60° C. to less than 100° C., from about 60° C. to about 98° C., or from about 60° C. to about 95° C. In embodiments, the acid leaching process 120 may comprise contacting the glass particles 112 with the acid leaching solution 122 at a temperature of about 95° C.

During the acid leaching process 120, the weight ratio of liquid to solid may be sufficient to produce an acceptable extraction rate for lithium. The weight ratio of liquid to solid refers to the weight of the acid leaching solution 122 divided by the weight of the glass particles 112 added to the acid leaching solution 122. In embodiments, the weight ratio of liquid to solid during the acid leaching process 120 may be greater than or equal to about 3, or greater than or equal to about 5. When the weight ratio of liquid to solid is less than about 3, the amount of the acid leaching solution 122 may be insufficient and the concentration of lithium in the acid leaching solution 122 may build up quickly, which results in a smaller lithium concentration gradient and an insufficient mass transfer rate of the lithium from the glass particles 112 to the acid leaching solution 122. Thus, the extraction efficiency may be decreased when the weight ratio of liquid to solid is less than about 3. In embodiment, the weight ratio of liquid to solid may be from about 3 to about 10, from about 3 to about 5, or from about 5 to about 10. When the weight ratio of liquid to solid is greater than about 10 during the acid leaching process 120, additional calcium carbonate (CaCO₃) and/or sodium hydroxide (NaOH) may be required in downstream steps to neutralize and precipitate other extracted species from the leachate. In embodiments, the weight ratio of liquid to solid during the acid leaching process 120 is about 3. In embodiments, the weight ratio of liquid to solid during the acid leaching process 120 is about 10.

During the acid leaching process 120, the glass particles 112 may be contacted with the acid leaching solution 122 for an extraction duration sufficient to extract at least 80% by weight of the lithium from the glass particles 112. In embodiments, the extraction duration may be from about 30 minutes to about 24 hours, such as from about 30 minutes to about 12 hours, from about 30 minutes to about 4 hours, from about 30 minutes to about 3 hours, from about 30 minutes to about 1 hour, from about 1 hour to about 24 hours, from about 1 hour to about 12 hours, from about 1 hour to about 4 hours, from about 1 hour to about 3 hours, from about 3 hours to about 24 hours, or from about 3 hours to about 12 hours. It was found that most of the acid leaching of lithium from the glass particles 112 occurs in the first hour of the acid leaching process 120 at a temperature of about 95° C. and a weight ratio of liquid to solid of about 10. In embodiments, the extraction duration may be from about 1 hour to about 3 hours. In embodiments, the extraction duration may be about 3 hours. In embodiments, the acid leaching process 120 may comprise contacting the glass particles 112 having a lithium content of from 2 mol. % to 20 mol. % with the acid leaching solution 122 having a concentration of sulfuric acid of from 10 wt. % to 30 wt. % at 95° C., at a weight ratio of liquid to solids of from 3 to 10, for an extraction duration of from 1 hour to 3 hours to produce the leachate slurry 124.

The acid leaching process 120 has a high extraction efficiency for extracting lithium from waste glass. In embodiments, the acid leaching process 120 may have an extraction efficiency of greater than or equal to about 80%, greater than or equal to about 85%, or even greater than or equal to about 90%. The extraction efficiency refers to the amount of the lithium removed from the glass particles 112 as a percentage of the total amount of lithium in the glass particles 112 prior to the acid leaching process. The extraction efficiency can be on a mole basis, though it should be understood that the extraction efficiency is the same whether expressed on a weight basis or a mole basis, since the percentage is based solely on lithium with a defined relationship between weight and moles (i.e., molecular weight of lithium). Converting between a molar basis and a weight basis in this case provides the same result for extraction efficiency.

The leachate slurry 124 resulting from the acid leaching process 120 may comprise residual solids that are depleted in lithium and the leachate that comprises the acid leaching solution 120 enriched with lithium. The leachate slurry 124 may also contain other species extracted from the glass particles 112, such as but not limited to species containing aluminum (Al), calcium (Ca), magnesium (Mg), boron (B), sodium (Na), potassium (K), or other metal containing species. It was found that the acid leaching process extracts very little of silicon-containing species (e.g., silica) from the glass particles 112: the extraction rate of silica is less than 1%. Thus, greater than 99% of the silica stays in the glass particles 112, and the leachate slurry 124 may comprise less than 200 ppmw silicon-containing species.

Referring again to FIG. 1, following the acid leaching process 120, the leachate slurry 124 may be separated in solids removal process 130 downstream of the acid leaching process 120 to produce the acid leachate 132 and the residual solids 134. The solids removal process 130 may include any process or combination of processes suitable for separating the residual solids 134 from the acid leachate 132. Examples of solids removal processes 130 may include, but are not limited to filtration, vacuum filtration, centrifugation, decantation, other solid separation techniques, or combinations of these. The acid leachate 132 may comprise the components of the acid leaching solution 122 (i.e., water and sulfuric acid) as well as the lithium extracted from the glass particles 112. The acid leachate 132 may also include other species extracted from the glass particles, such as but not limited to species comprising Al, Ca, Mg, B, Na, K, or other alkali, alkaline earth or transition metals originally present in the glass.

The residual solids 134 may comprise the glass components remaining in the glass particles 112 and not extracted during the acid leaching process 120. The residual solids 134 may comprise less than about 20%, less than about 15%, or even less than 10% of the lithium originally present in the glass particles 112 prior to the acid leaching process, where the percentages are based on the moles of lithium, though in this case the percentages are the same whether expressed on a molar basis or a weight basis. In embodiments, the residual solids 134 may comprise from 0% to about 20%, from 0% to about 15%, from 0% to about 10%, from about 0.1% to about 20%, from about 0.1% to about 15%, or from about 0.1% to about 10% of the lithium originally present in the glass particles 112 prior to the acid leaching process 120. In embodiments, the residual solids 134 may have less than about 4 mol % lithium, less than about 2 mol % lithium, less than about 1 mol % lithium, less than about 0.5 mol % lithium, less than about 0.2 mol % lithium, or even less than about 0.1 mol % lithium. In embodiments, the residual solids 134 may have from 0 mol % to about 4 mol %, from 0 mol % to about 2 mol %, from 0 mol % to about 1 mol %, from 0 mol % to about 0.5 mol %, from 0 mol % to about 0.2 mol %, from 0 mol % to about 0.1 mol %, from about 0.0001 mol % to about 4 mol %, from about 0.0001 mol % to about 2 mol %, from about 0.0001 mol % to about 1 mol %, from about 0.0001 mol % to about 0.5 mol %, from about 0.0001 mol % to about 0.2 mol %, or from about 0.0001 mol % to about 0.1 mol % lithium based on the total moles of constituents in the residual solids, where the mol % in the residual solids is determined after removing any of the residual acid leaching solution from the surfaces of the residual solids 134. The residual solids 134 may comprise greater than 98%, greater than 99%, or even greater than 99.5% of the silica originally present in the glass particles 112 prior to the acid leaching process 120, on a mole basis.

Referring again to FIG. 1, following separation of the leachate slurry 124 into the acid leachate 132 and the residual solids 134, the acid leachate 132 may be passed to a lithium separation process 200 for recovery of the lithium from the acid leachate 132. The separation process 200 may be operable to recover the lithium from the acid leachate 132 through precipitation of lithium salts 202 from the acid leachate 132 followed by separation of the lithium salts 202 from the acid leachate 132. The acid leachate 132 may be further separated into one or more by-product streams 204, as will be discussed in further detail herein. In embodiments, recovering the lithium from the acid leachate 132 in the lithium separation process 200 may include precipitating one or more lithium salts 202 from the acid leachate 132 and separating the lithium salts 202. Precipitating the lithium salts 202 from the leachate may comprise contacting at least a portion of the acid leachate 132 with a precipitating agent 206 comprising sodium carbonate, sodium phosphate, or both, wherein the precipitating agent 206 reacts with the lithium in the acid leachate 132 to produce the lithium salts 202, which precipitate out of the acid leachate 132.

In embodiments, the precipitating agent 206 may be sodium carbonate. The sodium carbonate may react with the lithium in the acid leachate 132 to produce lithium salts comprising lithium carbonate. The sodium ions contributed by the sodium carbonate may form sodium sulfates in the presence of the residual sulfuric acid in the acid leachate 132. The following chemical reaction 1 (RXN 1) shows the reaction of the sodium carbonate to produce the lithium carbonate precipitate.

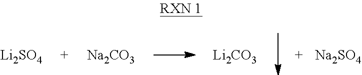

Lithium carbonate is at least partially soluble in water. This solubility limit can be at least partially overcome by increasing the concentration of lithium in the acid leachate 132 prior to adding the sodium carbonate. The concentration of lithium in the acid leachate 132 may be increased by evaporating at least a portion of the water in the acid leachate 132 to produce a concentrated acid leachate before adding the sodium carbonate. In embodiments, the process of precipitating the lithium salts 202 from the acid leachate 132 using sodium carbonate may include evaporating water from the acid leachate 132 until a concentration of lithium in the acid leachate 132 is greater than or equal to about 20 g/L to produce a concentrated acid leachate and, after evaporating the water, contacting the concentrated acid leachate with the sodium carbonate. In some instances, evaporating water from the acid leachate 132 may cause precipitation of other solid components. In embodiments, the methods of recovering the lithium from the acid leachate 132 using sodium carbonate as the precipitating agent 206 may further include filtering precipitated solids from the concentrated acid leachate after evaporating the water and before contacting the concentrated acid leachate with the sodium carbonate.

Additionally or alternatively, in embodiments, the precipitating agent 206 may be sodium phosphate. Sodium phosphate may be better suited for situations in which a concentration of lithium in the acid leachate 132 (or in the base leachate 152—FIG. 2) is less than 1000 ppm. When the concentration of lithium ions in the acid leachate 132 is less than about 1000 ppm, then using NaCO₃ as the precipitating agent 206 may require evaporation of a significant amount of water to reach the 20 g/L threshold. Thus, sodium phosphate, which produces lithium phosphate having lower solubility in water, may provide more efficient separation of the lithium from the acid leachate 132 when the lithium concentration is less than 1000 ppm. The sodium phosphate may react with the lithium in the acid leachate 132 to produce lithium salts comprising lithium phosphate. The sodium ions contributed by the sodium phosphate may form sodium sulfates in the presence of the residual sulfuric acid in the acid leachate 132. The following chemical reaction 2 (RXN 2) shows the reaction of the sodium phosphate to produce the lithium phosphate precipitate.

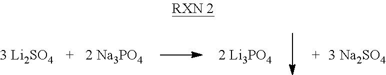

In addition to lithium phosphate, reaction of the sodium phosphate with the lithium in the acid leachate 132 may also produce sodium lithium phosphates, which may also precipitate out of the acid leachate 132. Thus, in embodiments, the precipitating agent may be sodium phosphate, and the lithium salts may include lithium phosphate, sodium lithium phosphates, or combinations of these.

The solubility of the lithium phosphates, sodium lithium phosphates, or both in water at high pH are less than the solubility of the lithium carbonates in water at high pH. Therefore, evaporating water from the acid leachate prior to adding the precipitating agent 206 may not be necessary when sodium phosphate is used as the precipitating agent 206. In embodiments, the lithium separation process 200 for separating the lithium from the acid leachate 132 may include adding the precipitating agent 206 comprising sodium phosphate directly to the acid leachate 132 without removing any water from the acid leachate 132.

Whether sodium carbonate or sodium phosphate is used as the precipitating agent 206, following adding the precipitating agent 206 to the portion of the acid leachate, the resulting lithium precipitation mixture is allowed to precipitate and then the lithium precipitation mixture may be subjected to a solid separation step to separate the lithium precipitation mixture into the lithium salt 202, which are solids, and one or more byproduct stream 204, which may include the remaining portions of the acid leachate. The lithium precipitation mixture may be separated in a solid separation process, such as any of the solid separation processes previously described herein. Examples of solid separation processes may include, but are not limited to filtration, vacuum filtration, centrifugation, decantation, other solid separation techniques, or combinations of these.

As previously discussed, the acid leaching process 120 may cause leaching of various non-lithium species from the glass particles 112 into the acid leaching solution 122. These non-lithium species may include aluminum, alkaline earth metals, boron, alkali metals, transition metals, or other constituents of the glass. In embodiments, the lithium separation process 200 may include additional process steps to remove one or more of the additional extracted species. In embodiments, recovering the lithium from the acid leachate may further comprise removing aluminum constituents, alkaline earth metal constituents, boron constituents, or combinations of these from the acid leachate. In embodiments, processes for removal of the aluminum, alkaline earth metals, boron, or combinations of these may be conducted prior to precipitating the lithium salts from the acid leachate. The lithium separation process 200 will be discussed in further detail herein.

In embodiments, the residual solids 134 may be subjected to one or more subsequent acid leaching processes (not shown) to extract additional lithium from the residual solids 134. In embodiments, the acid leaching process 120 may include a plurality of acid leaching steps in series.

In embodiments, the lithium may be extracted from the glass particles 112 using a base leaching process conducted at high pH instead of at low pH. Referring now to FIG. 2, in embodiments, the glass particles 112 may be passed to a base leaching process 140. In the base leaching process 140, the glass particles 112 may be contacted with a base leaching solution 142 comprising at least one base and water. In embodiments, the base leaching solution 142 may also include calcium oxide (CaO). Contact of the glass particles 112 with the base leaching solution 142 may cause extraction of lithium and other constituents from the glass particles 112 into the base leaching solution 142 to produce a base leachate slurry 144 comprising a liquid phase enriched with lithium and the residual solids, which are depleted of lithium. The base leachate slurry 144 may then be separated in a solids removal process 150 to produce the base leachate 152 and the residual solids 154. The base leachate 152 may then be passed to a lithium recovery process 400 for recovery of the lithium from the base leachate 152. The base leaching process 140 may result in less extraction of aluminum compared to the acid leaching process 120. The lower extraction efficiency for aluminum of the base leaching process 140 may reduce the complexity and expense of removing aluminum constituents from the base leachate 152 in the lithium separation process 400.

For the base leaching solution 142, the base may be selected from the group consisting of sodium hydroxide (NaOH), potassium hydroxide (KOH), or combinations of these. The base leaching solution 142 may have a concentration of the base sufficient to provide a high extraction rate sufficient to extract at least 80% of the lithium from the glass particles 112 in a leaching duration of less than 3 hours. In embodiments, the base leaching solution 142 may have a concentration of the base of greater than or equal to about 10 wt. %, greater than or equal to about 12 wt. %, greater than or equal to about 15 wt. %, or even greater than or equal to about 20 wt. % based on the total weight of the base leaching solution 142 prior to contact with the glass particles 112. When the concentration of the base is less than about 10 wt. %, the leaching rate of the base leaching solution 142 may be too low. In embodiments, the base leaching solution 142 may have a concentration of the base of less than about 70 wt. %, less than or equal to about 50 wt. %, or less than or equal to about 30 wt. %, or even less than or equal to about 20 wt. % based on the total weight of the base leaching solution 142 prior to adding the glass particles 112. Increasing the concentration of the base may increase the cost of extracting the lithium from the glass particles 112, such as by requiring additional amounts of reagents to neutralize the base leaching solution to precipitate out extracted species other than lithium, such as aluminum, calcium, and magnesium. In embodiments, the base leaching solution 142 may comprise from about 10 wt. % to about 70 wt. %, from about 10 wt. % to about 50 wt. %, from about 10 wt. % to about 30 wt. %, from about 10 wt. % to about 20 wt. %, from about 12 wt. % to about 70 wt. %, from about 12 wt. % to about 50 wt. %, from about 12 wt. % to about 30 wt. %, from about 12 wt. % to about 20 wt. %, from about 15 wt. % to about 70 wt. %, from about 15 wt. % to about 50 wt. %, from about 15 wt. % to about 30 wt. %, or from about 15 wt. % to about 20 wt. % of the base based on the total weight of the base leaching solution 142 before contacting with the glass particles 112. In embodiments, the base leaching solution 142 may comprise about 10 wt. % of the base, or about 20 wt. % of the base.

When extracting lithium using a base leaching solution 142, the base leaching solution 142 may extract a greater amount of the silica from the glass particles 112 compared to leaching using the acid leaching solution. With just the base and water, the liquid phase of the base leachate slurry 144 can contain up to or even exceeding 11,000 ppm silica. The greater silica content of the liquid phase of the base leachate slurry 144 can cause problems with the lithium recovery process 400 downstream of the base leaching process 140. The increased silica concentration in the liquid phase of the base leachate slurry 144 may require a separate de-silication process prior to separating any of the other extracted constituents from the base leachate 152. CaO may be added to the base leaching solution 142 to reduce the extraction of silica from the glass particles 112. In embodiments, the base leaching solution 142 may further include calcium oxide (CaO), which may be added to reduce extraction of silica from the glass particles 112. In embodiments, the base leaching solution 142 may comprise from about 5 wt. % to about 20 wt. % CaO based on the total weight of the base leaching solution 142 prior to adding the glass particles 112. In embodiments, the base leaching solution 142 may comprise from 5 wt. % to 18 wt. %, from 5 wt. % to 15 wt. %, from 5 wt. % to 12 wt. %, from 7 wt. % to 20 wt. %, from 7 wt. % to 18 wt. %, from 7 wt. % to 15 wt. %, from 7 wt. % to 12 wt. %, from 7 wt. % to 10 wt. %, from 10 wt. % to 20 wt. %, from 10 wt. % to 18 wt. %, from 10 wt. % to 15 wt. %, from 12 wt. % to 20 wt. %, from 12 wt. % to 18 wt. %, from 12 wt. % to 15 wt. %, from 15 wt. % to 20 wt. %, from 15 wt. % to 18 wt. %, or from 18 wt. % to 20 wt. % CaO based on the total weight of the base leaching solution. The addition of the CaO to the base leaching solution 142 may reduce extraction of silica from the glass particles 112 so that a concentration of silica in the base leachate 152 is less than 4000 ppmw or even less than 3000 ppmw.

The base leaching process 140 may be conducted in a vessel in which the glass particles 112 are contacted with the base leaching solution 142. In embodiments, the base leaching process 140 may include mixing the glass particles 112 and the base leaching solution 142 throughout the leaching duration. The base leaching process 140 may include contacting the glass particles 112 with the base leaching solution 142 at a temperature of from about 25° C. to less than 100° C., such as a temperature of from about 25° C. to about 98° C., from about 25° C. to about 95° C., from about 50° C. to less than 100° C., from about 50° C. to about 98° C. from about 50° C. to about 95° C., from about 55° C. to less than 100° C., from about 55° C. to about 95° C., from about 60° C. to less than 100° C., from about 60° C. to about 98° C., or from about 60° C. to about 95° C. In embodiments, the base leaching process 140 may comprise contacting the glass particles 112 with the base leaching solution 142 at a temperature of about 95° C.

During the base leaching process 140, the weight ratio of liquid to solid may be sufficient to produce an acceptable extraction rate of lithium from the glass particles 112. For the base leaching process 140, the weight ratio of liquid to solid refers to the weight of the base leaching solution 142 divided by the weight of the glass particles 112 added to the base leaching solution 142. In embodiments, the weight ratio of liquid to solid during the base leaching process 140 may be greater than or equal to about 3, or greater than or equal to about 5. When the weight ratio of liquid to solid is less than about 3, the amount of the base leaching solution 142 may be insufficient and the concentration of lithium in the base leaching solution 142 may build up quickly, which results in a reduced lithium concentration gradient between the liquid and the solid and an insufficient mass transfer rate of the lithium from the glass particles 112 to the base leaching solution 142. Thus, the extraction efficiency may be decreased when the weight ratio of liquid to solid is less than about 3. In embodiments, the weight ratio of liquid to solid for the base leaching process 140 may be from about 3 to about 10, from about 3 to about 5, or from about 5 to about 10. When the weight ratio of liquid to solid is greater than about 10 during the base leaching process 140, additional reagents may be required in downstream steps to neutralize and precipitate other extracted species from the base leachate 152. In embodiments, the weight ratio of liquid to solid during the base leaching process 140 is about 3. In embodiments, the weight ratio of liquid to solid during the base leaching process 140 is about 10.

During the base leaching process 140, the glass particles 112 may be contacted with the base leaching solution 142 for an extraction duration sufficient to extract at least 70% by weight of the lithium from the glass particles 112. In embodiments, the extraction duration may be from about 30 minutes to about 24 hours, such as from about 30 minutes to about 12 hours, from about 30 minutes to about 4 hours, from about 30 minutes to about 3 hours, from about 30 minutes to about 1 hour, from about 1 hour to about 24 hours, from about 1 hour to about 12 hours, from about 1 hour to about 4 hours, from about 1 hour to about 3 hours, from about 3 hours to about 24 hours, or from about 3 hours to about 12 hours. It was found that most of the base leaching of lithium from the glass particles 112 occurs in the 1-2 hours of the base leaching process 140 at a temperature of about 95° C. In embodiments, the extraction duration may be from about 1 hour to about 3 hours. In embodiments, the extraction duration may be about 3 hours. In embodiments, the base leaching process 140 may comprise contacting the glass particles 112 having a lithium content of from about 2 mol. % to about 20 mol. % with the base leaching solution 142 having a concentration of base of from about 10 wt. % to about 30 wt. % and a concentration of CaO of from about 5 wt. % to about 20 wt. %, wherein the base leaching process 140 is conducted at 95° C., at a weight ratio of liquid to solids of from 3 to 10, and for an extraction duration of from 1 hour to 3 hours to produce the base leachate slurry 144.

The base leaching process 140 has a high extraction efficiency for extracting lithium from the waste glass. In embodiments, the base leaching process 140 may have an extraction efficiency of greater than or equal to about 70%, greater than or equal to about 80%, greater than or equal to about 85%, or even greater than or equal to about 90%. The extraction efficiency refers to the amount of the lithium removed from the glass particles 112 as a percentage of the total amount of lithium in the glass particles 112 prior to the base leaching process 140. The extraction efficiency can be on a mole basis, though it should be understood that the extraction efficiency is the same whether expressed on a weight basis or a mole basis, since the percentage is based solely on lithium with a defined relationship between weight and moles (i.e., molecular weight of lithium). Converting between a molar basis and a weight basis in this case provides the same result for extraction efficiency.

The base leachate slurry 144 resulting from the base leaching process 140 may comprise residual solids that are depleted in lithium and the base leachate that comprises the acid leaching solution 140 enriched with lithium. The liquid phase of the base leachate slurry 144 may also contain other species extracted from the glass particles 112, such as but not limited to species containing aluminum (Al), calcium (Ca), magnesium (Mg), boron (B), sodium (Na), potassium (K), silicon (Si), or other metal containing species.

Referring again to FIG. 2, following the base leaching process 140, the base leachate slurry 144 may be separated in a solids removal process 150 downstream of the base leaching process 140 to produce the base leachate 152 and the residual solids 154. The solids removal process 150 may include any process or combination of processes suitable for separating the residual solids 154 from the base leachate 152. Examples of solids removal processes 150 may include, but are not limited to, filtration, vacuum filtration, centrifugation, decantation, other solid separation techniques, or combinations of these. The base leachate 152 may comprise the components of the base leaching solution 142 (i.e., water, base, and optionally CaO) as well as the lithium extracted from the glass particles 112. The base leachate 152 may also include other species extracted from the glass particles, such as but not limited to species comprising Al, Ca, Mg, B, Na, K, Si, or other alkali, alkaline earth or transition metals originally present in the glass of the glass particles 112.

The residual solids 154 may comprise the glass components remaining in the glass particles 112 and not extracted during the base leaching process 140. The residual solids 154 may comprise less than about 30%, less than about 20%, less than about 15%, or even less than 10% of the lithium originally present in the glass particles 112 prior to the base leaching process 140, where the percentages are based on the moles of lithium, though in this case the percentages are the same whether expressed on a molar basis or a weight basis. In embodiments, the residual solids 154 may comprise from 0% to about 20%, from 0% to about 15%, from 0% to about 10%, from about 0.1% to about 20%, from about 0.1% to about 15%, or from about 0.1% to about 10% of the lithium originally present in the glass particles 112 prior to the base leaching process 140. In embodiments, the residual solids 154 may have less than about 4 mol % lithium, less than about 2 mol % lithium, less than about 1 mol % lithium, less than about 0.5 mol % lithium, less than about 0.2 mol % lithium, or even less than about 0.1 mol % lithium. In embodiments, the residual solids 154 may have from 0 mol % to about 4 mol %, from 0 mol % to about 2 mol %, from 0 mol % to about 1 mol %, from 0 mol % to about 0.5 mol %, from 0 mol % to about 0.2 mol %, from 0 mol % to about 0.1 mol %, from about 0.0001 mol % to about 4 mol %, from about 0.0001 mol % to about 2 mol %, from about 0.0001 mol % to about 1 mol %, from about 0.0001 mol % to about 0.5 mol %, from about 0.0001 mol % to about 0.2 mol %, or from about 0.0001 mol % to about 0.1 mol % lithium based on the total moles of constituents in the residual solids 154, where the mol % in the residual solids is determined after removing any of the base leachate 152 from the surfaces of the residual solids 154. The residual solids 154 may comprise greater than 98%, greater than 99%, or even greater than 99.5% of the silica originally present in the glass particles 112 prior to the base leaching process 140, on a mole basis.

Referring again to FIG. 2, following separation of the base leachate slurry 144 into the base leachate 152 and the residual solids 154, the base leachate 152 may be passed to a lithium separation process 400 for recovery of the lithium from the base leachate 152. Similar to the separation process 200 of FIG. 1, the separation process 400 in FIG. 2 for the base leaching may be operable to recover the lithium from the base leachate 152 through precipitation of lithium salts 202 from at least a portion of the base leachate 152 followed by separation of the lithium salts 202 from the base leachate 152. The base leachate 152 may be further separated into one or more by-product streams 404, as will be discussed in further detail herein. The lithium salts 202 may be the same as those produce from the separation process 200 in FIG. 1, however, the byproducts streams 404 of the separation process 400 may be different from the byproduct streams 204 produced by separation process 200 due to the different chemical composition of the base leachate 152 compared to the acid leachate 132.

In embodiments, recovering the lithium from the base leachate 152 in the lithium separation process 400 may include precipitating one or more lithium salts 202 from the base leachate 152 and separating the lithium salts 202. Precipitating the lithium salts 202 from the base leachate 152 may comprise contacting at least a portion of the base leachate 152 with a precipitating agent 206 comprising sodium carbonate, sodium phosphate, or both, wherein the precipitating agent 206 reacts with the lithium in the base leachate 152 to produce the lithium salts 202, which precipitate out of the base leachate 152. Precipitating the lithium salts from the base leachate 152 using sodium carbonate, sodium phosphate, or both is the same as previous described in relation to precipitating and separating the lithium salts form the acid leachate 132, which was previously described herein.

In embodiments, the residual solids 154 may be subjected to one or more subsequent base leaching processes (not shown) to extract additional lithium from the residual solids 154. In embodiments, the base leaching process 140 may include a plurality of base leaching steps in series.

As previously discussed, the acid leaching process 120 and the base leaching processes 140 both result in extraction of several non-lithium containing constituents from the glass particles 112. These non-lithium containing constituents may include constituents comprising one or more of Al, Ca, Mg, B, Na, K, Si, or combinations of these. Recovering the lithium in the lithium separation process 200 or the lithium separation process 400 may include removing aluminum containing constituents from the leachate, removing alkaline earth metal compounds from the leachate, removing boron compounds from the leachate, or combinations of these. In embodiments, the methods may include removing the aluminum and alkaline earth metal compounds from the leachate prior to precipitating the one or more lithium salts from the leachate and removing the lithium salts from the leachate.

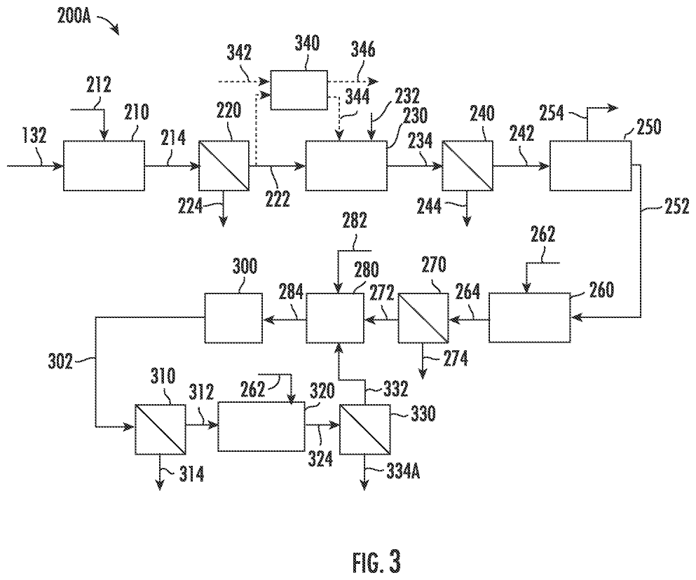

Referring now to FIG. 3, one embodiment of a lithium separation process 200A for recovering the lithium from the acid leachate 132 is graphically depicted. In the lithium separation process 200A of FIG. 3, the aluminum is removed from the acid leachate 132 through precipitation, followed by removal of alkaline metals through precipitation, followed by precipitation of the lithium salts using sodium carbonate as the lithium precipitating agent. Following separation of the lithium salts, the lithium separation process 200A may include removal of excess carbonate ions, concentration and crystallization of sodium sulfates, and then further precipitation and separation of lithium salts after the sodium sulfate removal.

In the lithium separation process 200A of FIG. 3, the acid leachate 132, which comprises the lithium ions leached from the glass particles 112, is passed to first to an aluminum precipitation process 210. In the aluminum precipitation process 210, a neutralizing agent 212 is added to the acid leachate 132 in an amount sufficient to adjust the pH into a range of from 6-7. The neutralization by the neutralizing agent 212 may cause aluminum compounds and some iron compounds, if present, to precipitate from the acid leachate 132 to produce an aluminum precipitation effluent 214. The neutralizing agent 212 may include one or more of calcium carbonate, calcium oxide, calcium hydroxide, sodium hydroxide, sodium carbonate, or combinations thereof.

When the glass composition of the glass particles 112 has a low concentration of calcium, such as a concentration of calcium of less than about 5 mol %, then using NaOH as the neutralizing agent 212 may enable precipitation of high purity aluminum hydroxide, which can be recovered and used as an alumina precursor in a glass or glass ceramic manufacturing process. High purity aluminum hydroxide (Al(OH)₃) refer to aluminum hydroxide having a purity of greater than or equal to 98 wt. %, or even greater than or equal to 99 wt. %. When using NaOH as the neutralizing agent 212 to produce high purity aluminum hydroxide, the neutralizing agent 212 may not contain sodium carbonate or any of the calcium-containing compounds, such as CaO, CaCO₃, or both.

When the concentration of calcium is greater than about 5 mol % in the glass particles 112 prior to acid leaching, then the concentration of calcium ions in the acid leachate 132 may be too high to produce a high purity aluminum hydroxide that would be suitable for use as an alumina precursor in glass manufacturing. In these instances, the neutralizing agent may be any one of calcium carbonate, calcium oxide, calcium hydroxide, sodium hydroxide, sodium carbonate, or combinations thereof, and the resulting aluminum-containing solids may be recycled as a raw material in the aluminum industry. When CaCO₃ or CaO are used as the neutralization agent, the lower purity Al(OH)₃ that results can be easily digested in the traditional Bayer aluminum process.

Following the aluminum precipitation process 210, the aluminum precipitation effluent 214 may be passed to an aluminum solids separation process 220, which may be operable to separate the aluminum precipitation effluent 214 into an aluminum depleted filtrate 222 and the aluminum-containing solids 224. The aluminum solids separation process 220 may be any of the solid liquid separation processes or combinations of processes previously discussed herein for the solids removal process 130 (FIG. 1).

In embodiments, removing the aluminum from the acid leachate 132 may comprise precipitating one or more aluminum compounds from the acid leachate 132 to produce the aluminum precipitation effluent 214 and then filtering the one or more aluminum compounds from the aluminum precipitation effluent 214 to produce the aluminum depleted filtrate 222 and the aluminum containing solids 224. Precipitating the aluminum compounds may comprise neutralizing the leachate to a pH in a range of from 6-7 with the neutralizing agent 212, wherein neutralizing the leachate precipitates aluminum and iron containing solids from the acid leachate 132. In embodiments, when the glass particles 112 comprises less than 5 mol % calcium compounds based on the total moles of glass, neutralizing the acid leachate 132 may comprise adding NaOH to the acid leachate 132 as the neutralizing agent 212, wherein the NaOH produces the aluminum containing solids 224 comprising highly pure aluminum hydroxide. In embodiments, when the glass particles 112 comprise greater than 5 mol % calcium, then neutralizing the acid leachate 132 may comprise adding any one of calcium carbonate, calcium oxide, calcium hydroxide, sodium hydroxide, sodium carbonate, or combinations thereof to the acid leachate 132.

Referring again to FIG. 3, following removal of the aluminum in the aluminum precipitation process 210 and aluminum solid separation process 220, the aluminum depleted filtrate 222 may be passed to an alkaline earth metal precipitation process 230 operable to precipitate alkaline earth metal compounds from the aluminum depleted filtrate 222. In the alkaline earth metal precipitation process 230, a base 232 may be added to the aluminum depleted filtrate 222 to increase the pH of the aluminum depleted filtrate 222 a pH range of from 12-14, or from 12-13. The base 232 may include CaO, Ca(OH)₂, Na₂CO₃, NaOH, or combinations of these. Increasing the pH of the aluminum depleted filtrate 222 into the range of 12-14 may cause alkaline earth metals, such as but not limited to Mg, Ca, Ba, Sr, to precipitate out of the aluminum depleted filtrate 222 to produce an alkaline earth precipitation effluent 234 comprising a liquid phase and a solid phase. In embodiments, the methods disclosed herein may include increasing the pH of the aluminum depleted filtrate 222 to a pH range of from 12 to 13 by adding lime, calcium carbonate, sodium hydroxide, sodium carbonate, or combinations of these to the aluminum depleted filtrate 222, wherein increasing the pH into the range of 12 to 13 causes precipitation of alkaline earth metals, such as magnesium and calcium species, from the aluminum depleted filtrate 222.

After precipitation, the alkaline earth precipitation effluent 234 may be passed to an alkaline earth solids separation process 240, which may be operable to separate the alkaline earth precipitation effluent 234 to produce a lithium-containing filtrate 242 and the alkaline earth metal solids 244. The alkaline earth solids separation process 240 may be any of the solid liquid separation processes or combinations of processes previously discussed herein for the solids removal process 130 (FIG. 1). The methods disclosed herein may include filtering the alkaline earth precipitation effluent 234 to produce the lithium-containing filtrate 242 and the alkaline earth metal solids 244. The alkaline earth metal solids 244 may be removed from the process, and may be recycled or otherwise disposed of according to acceptable practices.

Referring again to FIG. 3, following removal of the alkaline earth metal constituents, the lithium-containing filtrate 242 may be treated to precipitate lithium salts, and the lithium salts may then be recovered through filtration of the precipitated lithium salts from the liquids. In embodiments represented by FIG. 3, sodium carbonate is used as the lithium precipitating agent 206 (FIG. 1). As a result, the lithium-containing filtrate 242 may be first passed to an evaporation process 250 to produce a concentrated lithium containing filtrate 252, and the concentrated lithium containing filtrate 254 may be treated with the sodium carbonate 262 in the lithium precipitation process 260 to precipitate the lithium carbonate salts. In the evaporation process 250, water 254 may be evaporated from the lithium-containing filtrate 242 until the concentration of lithium in the concentrated lithium containing filtrate 252 is greater than or equal to about 20 grams per liter. The concentrated lithium containing filtrate 252 may then be passed to the lithium precipitation process 260. In the lithium precipitation process 260, the sodium carbonate 262 may be added to the concentrated lithium containing filtrate 252, which may cause precipitation of lithium carbonate salts to produce a lithium precipitation effluent 264. The lithium precipitation mixture 264 may include the lithium carbonate salts as a solid phase dispersed in the liquid phase.

The lithium precipitation mixture 264 may be passed downstream to the lithium salt separation process 270, which may be operable to separation the lithium precipitation mixture 264 to produce a lithium depleted filtrate 272 and the lithium carbonate salts 274. The lithium salt separation process 270 may be any of the solid liquid separation processes or combinations of processes previously discussed herein for the solids removal process 130 (FIG. 1). The methods disclosed herein may include filtering the lithium precipitation mixture 264 to produce the lithium depleted filtrate 272 and the lithium carbonate salts 274. The lithium carbonate salts 274 may make up at least a portion of the lithium salts 202 recovered from the lithium separation process 200 (FIG. 1).

In embodiments, the methods disclosed herein may include precipitating lithium salts from the lithium containing filtrate 242 using sodium carbonate 262 as the precipitating agent. In embodiments, precipitating the lithium salts may include evaporating water from the lithium-containing filtrate 242 until the concentration of lithium in the lithium containing filtrate 242 is greater than or equal to 20 g/L to produce the concentrated lithium-containing filtrate 252, and then precipitating the lithium carbonate salts from the concentrated lithium containing filtrate 252 by adding sodium carbonate to the concentrated lithium-containing filtrate 252 to produce the lithium precipitation effluent 264. The methods may further comprise filtering the lithium precipitation effluent 264 to produce the lithium depleted filtrate 272 and the lithium carbonate salts 274. In embodiments, the methods may further include purifying the lithium carbonate salts 274 by washing with hot water.

Following precipitation and recovery of the lithium as the lithium carbonate salts 274, the lithium depleted filtrate 272 may still contain a substantial concentration of lithium. This remaining lithium may be further recovered from the lithium depleted filtrate 272 by further processing the lithium depleted filtrate 272 to remove excess carbonate ions, crystallize and remove sodium sulfates, and then recover additional lithium from the crystallization mother liquor.

Referring again to FIG. 3, the lithium depleted filtrate 272 may be passed downstream to a carbonate removal process 280, which may be operable to remove carbonate and hydroxide ions from the lithium depleted filtrate 272. In the carbonate removal process 280, sulfuric acid 282 may be added to the lithium depleted filtrate 272. The sulfuric acid 282 may react with the carbonate ions in the lithium depleted filtrate 272 to break down the carbonate ions to produce carbon dioxide, water, and sodium sulfate. The carbon dioxide may be passed out of the system in a gas stream. Additionally, the sulfuric acid 282 may react with hydroxide ions to produce water and sulfate ions. The resulting sodium sulfate solution 284 may be generally free of carbonate ions and hydroxide ions.

The sodium sulfate solution 284 may then be passed downstream to a sodium sulfate crystallization process 300, which may be operable to crystalize the sodium sulfate to produce a crystallization effluent 302. The sodium sulfate crystallization process 300 may be operable to reduce a temperature of the sodium sulfate solution 284, which may cause the sodium sulfate to crystallize to produce the crystallization effluent 302 comprising solid sodium sulfate crystals dispersed in the crystallization mother liquor. The crystallization effluent 302 may be passed downstream to a crystallization solid separation process 310, which may separate the crystallization effluent 302 to produce the crystallization mother liquor 312 and the sodium sulfate solids 314. The crystallization solid separation process 310 may be any of the solid liquid separation processes or combinations of processes previously discussed herein for the solids removal process 130 (FIG. 1). Any of the methods discussed herein may include cooling the sodium sulfate solution, wherein the cooling crystallizes sodium sulfate causes crystallization of the sodium sulfate, and separating the crystallized sodium sulfate from the cooled sodium sulfate solution to produce the sodium sulfate solids 314 and the crystallization mother liquor 312.

Referring again to FIG. 3, following crystallization and removal of sodium sulfate, the crystallization mother liquor may be further treated with the precipitating agent to recover additional lithium from the crystallization mother liquor. In embodiments, the crystallization mother liquor 312 may be passed to a final lithium precipitation process 320, which may be operable to precipitate any residual lithium from the crystallization mother liquor 312 through addition of sodium carbonate 262 as the precipitating agent. The final lithium precipitation effluent 324 comprising the precipitated lithium carbonate salts may be passed to a lithium solid separation process 330, which may separate the final lithium precipitation effluent 324 into the lithium depleted mother liquor 332 and the lithium carbonate salts 334.

The methods disclosed herein may comprise recovering residual lithium ions from the crystallization mother liquor 312. Recovering the residual lithium ions from the crystallization mother liquor 312 may comprise adding sodium carbonate 262 to the crystallization mother liquor 312 to precipitate lithium carbonate salts and the separating the lithium carbonate solid from the crystallization mother liquor to produce a lithium depleted mother liquor. The methods may further include recycling the lithium depleted mother liquor back to the carbonate removal process 280.

The lithium salts 202 (FIG. 1) recovered from the lithium separation process 200A may include the lithium carbonate salts 274 separated from the lithium precipitation mixture 264 and the lithium carbonate salts 334 recovered from the crystallization mother liquor 312. The by-product streams 204 (FIG. 1) from the lithium separation process 200A may include the aluminum containing solids 224, the alkaline earth metal solids 244, and the sodium sulfate solids 314. The by-product streams 204 may further include water evaporated from the lithium-containing filtrate 242, carbon dioxide produced from the carbonate removal process 280, or both.

Referring again to FIG. 3, in embodiments, the lithium separation process 200A may further include a boron extraction process 340, which may be operable to remove boron species from at least a portion of the acid leachate 132. The boron extraction process 340 may comprise contacting the boron containing stream with an organic solvent 342, which reacts with the boron species to produce boric acid. In embodiments, the organic solvent 342 may be iso-octyl alcohol. The boric acid may be extracted into the organic phase to produce a two phase extraction effluent comprising an aqueous phase 344 and the organic phase 346. The extraction effluent may be separated into the aqueous phase 344 and the organic phase 346. The aqueous phase 344 may be passed downstream in the lithium separation process 200A, while the organic phase 346 comprising the boric acid may be removed from the process. In embodiments represented by FIG. 3, the boron extraction process 340 may be disposed between the aluminum solid separation process 220 and the alkaline earth precipitation process 230. The aluminum depleted filtrate 222 may be passed from the aluminum solids separation process 220 to the boron extraction process 340, and the aqueous phase 344 recovered from the boron extraction process 340 may be passed downstream to the alkaline earth precipitation process 230 following extraction of the boron species. In embodiments, the by-product streams 204 may include the organic phase 346 from the boron extraction process 340.

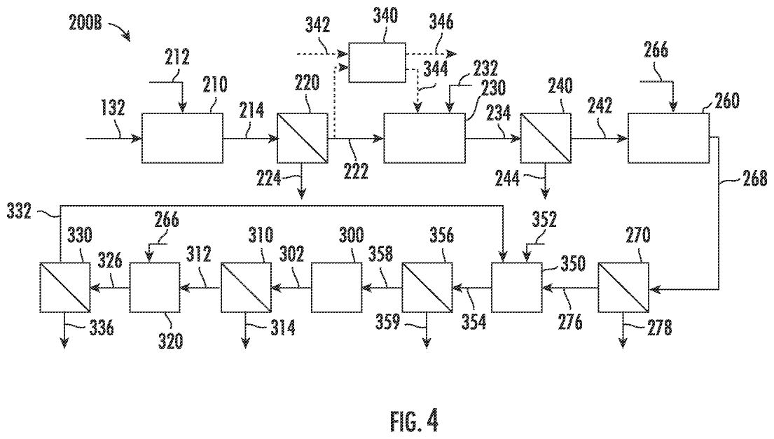

Referring now to FIG. 4, in embodiments, the lithium separation system 200B may use sodium phosphate as the precipitating agent to precipitate lithium phosphate instead of using sodium carbonate to precipitate lithium carbonate. As previously discussed herein, the solubility of lithium phosphate in water is less than the solubility of lithium carbonate in water. Therefore, using sodium phosphate to precipitate lithium phosphate does not require the evaporation process 250 from the lithium separation system 200A.

Referring to FIG. 4, the lithium separation system 200B may include the aluminum precipitation process 210, the aluminum solids separation process 220, the boron extraction process 340, the alkaline earth precipitation process 230, and the alkaline earth solids separation process 240, which may all be operated as previously described in relation to the lithium separation system 200A in FIG. 3. For the lithium separation system 200B in FIG. 4, the lithium-containing filtrate 242 may be passed from the alkaline earth solids separation process 240 directly to the lithium precipitation process 260. The lithium separation process 200B shown in FIG. 4 does not include an evaporation process to evaporate water from the lithium-containing filtrate 242. Further, when the sodium phosphate is used as the precipitating agent, the lithium separation process 200B may include a phosphate removal process 350 and phosphate solids separation process 356 in place of the carbonate removal process 280.

Referring again to FIG. 4, in embodiments, the lithium-containing filtrate 242 may be passed to the lithium precipitation process 260, which may be operable to contact the lithium-containing filtrate 242 with sodium phosphate to precipitate the lithium phosphate salts. In the lithium precipitation process 260, the sodium phosphate 266 may be added directly to the lithium-containing filtrate 242, which may cause precipitation of lithium phosphate salts to produce a lithium precipitation mixture 268. The lithium precipitation mixture 268 may include the lithium phosphate salts as a solid phase dispersed in the liquid phase.

The lithium precipitation mixture 268 may be passed downstream to the lithium salt separation process 270, which may be operable to separation the lithium precipitation mixture 268 to produce a lithium depleted filtrate 276 and the lithium phosphate salts 278. The lithium salt separation process 270 may be any of the solid liquid separation processes or combinations of processes previously discussed herein for the solids removal process 130 (FIG. 1). The methods disclosed herein may include filtering the lithium precipitation mixture 268 to produce the lithium depleted filtrate 276 and the lithium phosphate salts 278. The lithium phosphate salts 278 may make up at least a portion of the lithium salts 202 recovered from the lithium separation process 200 of FIG. 1.

In embodiments, the methods disclosed herein may include precipitating lithium salts from the lithium-containing filtrate 242 using sodium phosphate 266 as the precipitating agent. In embodiments, precipitating the lithium salts may include precipitating the lithium phosphate salts from the lithium-containing filtrate 242 by adding sodium phosphate to the lithium-containing filtrate 242 to produce the lithium precipitation effluent 268. The methods may further comprise filtering the lithium precipitation effluent 268 to produce the lithium depleted filtrate 276 and the lithium phosphate salts 278. In embodiments, the methods may further include purifying the lithium phosphate salts 278 by washing with hot water (not shown).

The lithium depleted filtrate 276 may include excess phosphate ions. In embodiments, the lithium depleted filtrate 276 may be passed to a phosphate ion removal process 350. The phosphate ion removal process 350 may be operable to contact the lithium depleted filtrate 276 comprising the excess phosphate with lime 352, where the lime reacts with the phosphate ions to produce calcium phosphate, which precipitates out of the lithium depleted filtrate to produce a phosphate removal effluent 354. The phosphate removal effluent 354 may be passed downstream to a phosphate solids separation process 356, which may be operable to separate the phosphate removal effluent 354 into a phosphate depleted filtrate 358 and the calcium phosphate solids 359.

The phosphate depleted filtrate 358 may comprise sodium sulfates. The phosphate depleted filtrate 358 may be passed to the sodium sulfate crystallization process 300, which may be operable to crystallize sodium sulfates from the phosphate depleted filtrate 358. The sodium sulfate crystallization process 300 and sodium sulfate solids separator 310 may be operated as previously discussed in relation to the lithium separation process 200A of FIG. 3 to produce the crystallization mother liquor 312 and the sodium sulfate solids 314.

The crystallization mother liquor 312 may include some residual lithium ions. Referring again to FIG. 4, in embodiments, the crystallization mother liquor 312 may be passed from the sodium sulfate solids separator 310 to a final lithium precipitation process 320, which may be operable to precipitate the residual lithium from the crystallization mother liquor 312. The final lithium precipitation process 320, may be operable to precipitate any residual lithium from the crystallization mother liquor 312 through addition of sodium phosphate 266 as the precipitating agent. The final lithium precipitation effluent 326 comprising the precipitated lithium phosphate salts may be passed to a lithium solid separation process 330, which may separate the final lithium precipitation effluent 326 into the lithium depleted mother liquor 332 and the lithium phosphate salts 336.

Referring to FIG. 4, the methods disclosed herein may comprise recovering residual lithium ions from the crystallization mother liquor 312. Recovering the residual lithium ions from the crystallization mother liquor 312 may comprise adding sodium phosphate 266 to the crystallization mother liquor 312 to precipitate lithium phosphate salts and the separating the lithium phosphate solids from the crystallization mother liquor to produce a lithium depleted mother liquor. The methods may further include recycling the lithium depleted mother liquor back to the phosphate removal process 350.

The lithium salts 202 (FIG. 1) recovered from the lithium separation process 200B of FIG. 4 may include the lithium phosphate salts 278 separated from the lithium precipitation mixture 268 and the lithium phosphate salts 336 recovered from the crystallization mother liquor 312. The by-product streams 204 (FIG. 1) from the lithium separation process 200B of FIG. 4 may include the aluminum containing solids 224, the alkaline earth metal solids 244, the calcium phosphate solids 359, and the sodium sulfate solids 314. In embodiments, the by-product streams 204 may further include the organic phase 346 from the boron extraction process 340.

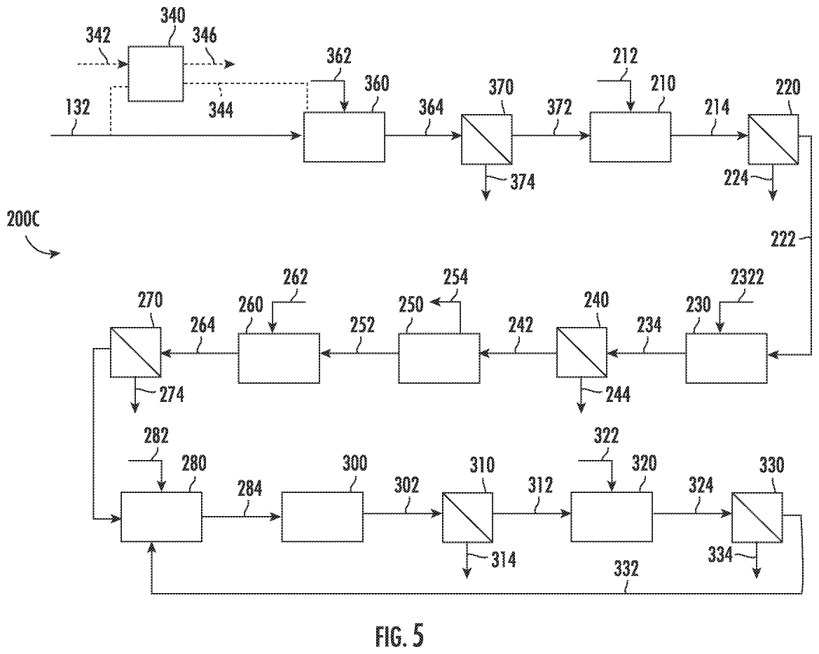

Referring now to FIG. 5, in embodiments, the lithium separation process 200C may include an aluminum crystallization process 360 for improving separation of the aluminum from the acid leachate 132. When the lithium separation process 200C comprises the boron extraction process 340, the boron extraction process 340 may be disposed upstream of the aluminum crystallization process 360. The acid leachate 132 may be passed to the boron extraction process 340, which may be operable to remove boron from the acid leachate 132 through extraction with iso-octyl alcohol 342 to produce the aqueous phase 344 and the organic phase 346. The aqueous phase 344 may be passed to the alum crystallization process 360. In embodiments, the lithium separation process 200C may not include the boron extraction process 340, in which case, the acid leachate 132 may be passed directly to the alum crystallization process 360.

In the alum crystallization process 360, a sulfate reagent 362 may be added to the acid leachate 132 or the aqueous phase 344 from the boron extraction process 340. The sulfate reagent 362 may include ammonium sulfate ((NH₄)₂SO₄), potassium sulfate (K₂SO₄) or combinations of these. The sulfate reagent 362 may react with the aluminum from the acid leachate 132 to produce alum (e.g., hydrated aluminum sulfate). The resulting liquid may be cooled to crystallize the alum to produce an alum crystallization effluent 364 comprising the crystallized alum solids dispersed in a liquid. The alum crystallization effluent 364 may be passed to an alum solids separator 370, which may be operable to separate the alum crystallization effluent 364 to produce an alum crystallization mother liquor 372 and the alum sulfate solids 374. The alum crystallization mother liquor 372 may comprise residual aluminum as well as the lithium, alkaline earth metals, and other constituents leached from the glass particles 112.

Referring again to FIG. 5, downstream of the alum solids separator 370, the lithium removal process 200C may comprise the aluminum precipitation process 210, the aluminum solids separation process 220, the alkaline earth precipitation process 230, and the alkaline earth solids separation process 240, each of which may be operated as previously described in relation to FIG. 3. As shown in FIG. 5, in embodiments, the lithium removal process 200C may use sodium carbonate 262 as the precipitating agent for precipitating lithium carbonate. In these embodiments, downstream of the alkaline earth solids separation process 240, the lithium removal process 200C may include the evaporation process 250, the lithium precipitation process 260, the lithium salt separation process 270, the carbonate removal process, the sodium sulfate crystallization process 300, the sodium sulfate solids separator 310, final lithium precipitation process 320, and lithium solid separation process 330, each of which may be operated in the manner described in relation to FIG. 3.

The lithium salts 202 (FIG. 1) recovered from the lithium separation process 200C may include the lithium carbonate salts 274 separated from the lithium precipitation mixture 264 and the lithium carbonate salts 334 recovered from the crystallization mother liquor 312. The by-product streams 204 (FIG. 1) from the lithium separation process 200C may include the alum solids 374, the aluminum containing solids 224, the alkaline earth metal solids 244, and the sodium sulfate solids 314. The byproduct streams 204 may further include water evaporated from the lithium-containing filtrate 242, carbon dioxide produced from the carbonate removal process 280, or both. The byproduct streams 204 may further include the organic phase 346 from the boron extraction process 340.

In embodiments, the lithium removal process 200C may use sodium phosphate 266 as the precipitating agent for precipitating lithium phosphate salts. In these embodiments, downstream of the alkaline earth solids separation process 240, the lithium removal process 200C may include the lithium precipitation process 260, the lithium salt separation process 270, the phosphate ion removal process 350, the phosphate solids separation process 360, the sodium sulfate crystallization process 300, the sodium sulfate solids separator 310, the final lithium precipitation process 320, and the lithium solid separation process 330, each of which may be operated in the manner described in relation to FIG. 4.

When sodium phosphate is used as the precipitating agent, the lithium salts 202 (FIG. 1) recovered from the lithium separation process 200C of FIG. 5 may include the lithium phosphate salts 278 separated from the lithium precipitation mixture 268 and the lithium phosphate salts 336 recovered from the crystallization mother liquor 312. The by-product streams 204 (FIG. 1) from the lithium separation process 200C of FIG. 4 may include the alum solids 374, the aluminum containing solids 224, the alkaline earth metal solids 244, the calcium phosphate solids 359, and the sodium sulfate solids 314. In embodiments, the by-product streams 204 may further include the organic phase 346 from the boron extraction process 340.

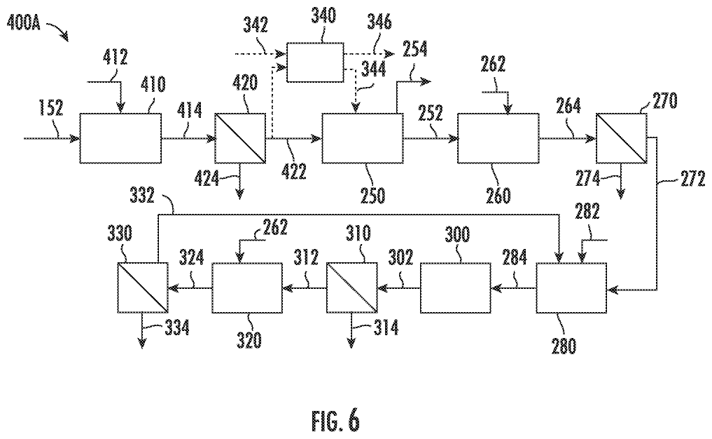

Referring now to FIG. 6, a lithium separation process 400A for separating lithium from the base leachate 152 produced from the base leaching process 140 depicted in FIG. 2. The base leaching process 140 of FIG. 2 results in less extraction of aluminum and alkaline earth metal constituents from the glass particles 112 compared to the acid leaching process 120 in FIG. 1. Therefore, the lithium separation process 400A downstream of the base leaching process may be simpler than the lithium separation process 200 for the acid leaching process. In particular, the lithium separation process 400A may not require separating alkaline earth metal constituents from the liquid phase. Thus, the lithium separation process 400A may not have an alkaline earth precipitation process. Further, the reduced concentration of aluminum in the base leachate 152 may allow the aluminum to be removed through precipitation only, without having the crystallize aluminum sulfates in the aluminum crystallization process discussed in relation to FIG. 5.

In the lithium separation process 400A of FIG. 6, sodium carbonate may be used as the precipitating agent for precipitating the lithium salts. The lithium separation process 400A may include an aluminum precipitation process 410, an aluminum solids separation process 420, the evaporation process 250, the lithium precipitation process 260, the lithium solids separation process 270, the carbonate removal process 280, the sodium sulfate crystallization process 300, the sodium sulfate solids separator 310, the final lithium precipitation process 320, and the lithium solids separation process 330 downstream of the final lithium precipitation process 320. In embodiments, the lithium separation process 400A may also include the boron extraction process 340 operable to remove boron species from the base leachate 152.

Referring to FIG. 6, the base leachate 152 may be passed directly to the aluminum precipitation process 410. Since the base leachate 152 has a high pH, the aluminum precipitation process 410 may be operable to neutralize the base leachate 152 by reducing the pH to the pH range of from 6-7 to precipitate the aluminum species. In the aluminum precipitation process 410, a neutralizing agent 412 is added to the base leachate 152 in an amount sufficient to adjust the pH down into a range of from 6-7. The neutralization by the neutralizing agent 412 may cause aluminum compounds and some iron compounds, if present, to precipitate from the base leachate 152 to produce an aluminum precipitation effluent 414. The neutralizing agent 412 may sulfuric acid. The aluminum may precipitate as aluminum hydroxide (Al(OH)₃). In embodiments, the aluminum hydroxide precipitate may have a high purity such that the aluminum hydroxide can be used as an alumina precursor in a glass or glass-ceramic manufacturing process.

Following the aluminum precipitation process 410, the aluminum precipitation effluent 414 may be passed to an aluminum solids separation process 420, which may be operable to separate the aluminum precipitation effluent 414 into an aluminum depleted filtrate 422 and the aluminum-containing solids 424. The aluminum solids separation process 420 may be any of the solid liquid separation processes or combinations of processes previously discussed herein for the solids removal process 130 (FIG. 1). As previously discussed, the aluminum-containing solids 424 may comprise high purity aluminum hydroxide, which may be used as an alumina precursor in a glass or glass-ceramic manufacturing process. In embodiments, the aluminum-containing solids 242 may be recycled as a raw material in an aluminum process.

In embodiments, the aluminum depleted filtrate 422 may be passed to the boron extraction process 340 for removal of the boron species. The boron extraction process 340 may be operated as described in relation to FIG. 3. The aqueous phase 344 may be passed to the evaporation process 250. In embodiments, the lithium separation process 400A may not include the boron extraction process 340, and the aluminum depleted filtrate 422 may be passed directly from the aluminum solids separation process 420 to the evaporation process 250. The evaporation process 250, the lithium precipitation process 260, the lithium solids separation process 270, the carbonate removal process 280, the sodium sulfate crystallization process 300, the sodium sulfate solids separator 310, the final lithium precipitation process 320, and the lithium solids separation process 330 may each be operated as previously discussed in relation to the lithium separation process 200A of FIG. 3.

The lithium salts 202 (FIG. 2) recovered from the lithium separation process 400A may include the lithium carbonate salts 274 separated from the lithium precipitation mixture 264 and the lithium carbonate salts 334 recovered from the crystallization mother liquor 312. The by-product streams 404 (FIG. 2) from the lithium separation process 400A may include the aluminum containing solids 424 and the sodium sulfate solids 314. The byproduct streams 404 may further include water evaporated from the lithium-containing filtrate 242, carbon dioxide produced from the carbonate removal process 280, or both. In embodiments, the byproduct streams 404 may further include the organic phase 346 from the boron extraction process 340.

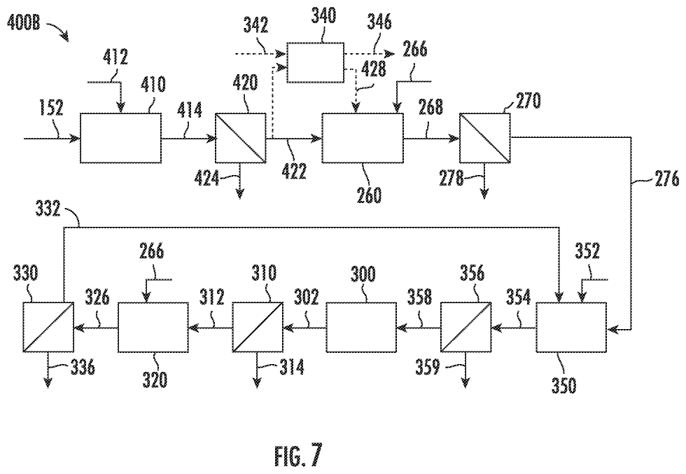

Referring now to FIG. 7, in embodiments, the lithium separation system 400B may use sodium phosphate as the precipitating agent to precipitate lithium phosphate from the base leachate 152 instead of using sodium carbonate to precipitate lithium carbonate. As previously discussed herein, the solubility of lithium phosphate in water is less than the solubility of lithium carbonate in water. Therefore, using sodium phosphate to precipitate lithium phosphate does not require the evaporation process 250 from the lithium separation system 400B.

Referring to FIG. 7, the lithium separation system 400B may include the aluminum precipitation process 410, the aluminum solids separation process 420, and the boron extraction process 340, which may all be operated as previously described in relation to the lithium separation system 400A in FIG. 6. For the lithium separation system 400B in FIG. 7, the aluminum depleted filtrate 422 may be passed from the aluminum solids separation process 420 directly to the lithium precipitation process 260. In embodiments, the lithium separation system 400B may include the boron extraction process 340, the aluminum depleted filtrate 422 may be passed to the boron extraction process 340, and the aqueous phase 344 may be passed from the boron extraction process 340 to the lithium precipitation process 260. The lithium separation process 400B shown in FIG. 7 does not include an evaporation process to evaporate water from the aluminum depleted filtrate 422 or the aqueous phase 344 prior to precipitation. Further, when the sodium phosphate is used as the precipitating agent, the lithium separation process 400B of FIG. 7 may include the phosphate removal process 350 and phosphate solids separation process 356 in place of the carbonate removal process 280.

Referring again to FIG. 7, downstream of the aluminum solids separation process 420, the lithium separation system 400B may comprise the lithium precipitation process 260, the lithium salt separation process 270, the phosphate ion removal process 350, the phosphate solids separation process 356, the sodium sulfate crystallization process 300, the sodium sulfate solids separator 310, the final lithium precipitation process 320, and the lithium solid separation process 330, each of which may be operated as previously described in relation to the lithium separation process 200B depicted in FIG. 4.

The lithium salts 202 (FIG. 2) recovered from the lithium separation process 400B of FIG. 7 may include the lithium phosphate salts 278 separated from the lithium precipitation mixture 268 and the lithium phosphate salts 336 recovered from the crystallization mother liquor 312. The byproduct streams 404 (FIG. 2) from the lithium separation process 400B of FIG. 7 may include the aluminum containing solids 424, the calcium phosphate solids 359, and the sodium sulfate solids 314. In embodiments, the byproduct streams 404 may further include the organic phase 346 from the boron extraction process 340.

Referring again to FIGS. 1 and 2, the lithium salts 202 (e.g., lithium carbonate, lithium phosphate, lithium sodium phosphate, etc.) recovered from the lithium separation process 200, 400 may be used as a lithium precursor in the glass or glass-ceramic manufacturing process to make lithium-containing glass and glass-ceramics.

The waste glass may be made from any glass composition or combinations of glass compositions comprising lithium, such as glass compositions comprising lithium oxide. In embodiments, the glass composition of the waste glass may include at least silica (SiO₂), alumina (AL₂O₃), and lithium oxide (LiO₂). The glass compositions may also include boron trioxide (B₂O₃), zirconia (ZrO₂), alkali metal oxides (e.g., Na₂O, K₂O, etc), alkaline metal oxides (e.g., MgO, CaO, SrO, BaO), titanium dioxide (TiO₂), tin oxide (SnO₂), or combinations thereof. In embodiments, the glass compositions may include other constituents, such as but not limited to P₂O₅, Co₃O₄, Cr₂O₃, CuO, Fe₂O₃, NiO, Sb₂O₃, ZnO, HfO₂, or combinations thereof. By way of example and not limitation, in embodiments, the waste glass may comprise one or a plurality of different glass compositions, where the glass compositions may comprise from 30 mol % to 85 mol % SiO₂, from 2 mol % to 30 mol % Al₂O₃, from 0 mol % to 20 mol % B₂O₃, from 2 mol % to 20 mol % LiO₂, from 0 mol % to 20 mol % Na₂O, from 0 mol % to 20 mol % K₂O, from 0 mol % to 20 mol % MgO, from 0 mol % to 20 mol % CaO, from 0 mol % to 10 mol % SrO, from 0 mol % to 10 mol % BaO, from 0 mol % to 5 mol % ZrO₂, from 0 mol % to 5 mol % Ti₂O, and from 0 mol % to 5 mol % Sn₂O.

SiO₂, an oxide involved in the formation of glass, can function to stabilize the networking structure of glasses. The amount of SiO₂ may be limited to control the melting temperature of the glass, since the melting temperatures of pure SiO₂ and glasses with high-SiO₂ concentration are high. In embodiments, the glass compositions of the waste glass may comprise from about 30 mol % to about 85 mol % SiO₂, based on the total moles of the glass or glass ceramic composition. In embodiments, the glass compositions of the waste glass may comprise from about 30 mol % to about 80 mol %, about 30 mol % to about 75 mol %, about 30 mol % to about 70 mol %, about 40 mol % to about 85 mol %, about 40 mol % to about 80 mol %, about 40 mol % to about 75 mol %, about 40 mol % to about 70 mol %, about 50 mol % to about 85 mol %, about 50 mol % to about 80 mol %, about 50 mol % to about 75 mol %, about 50 mol % to about 70 mol %, about 60 mol % to about 85 mol %, about 60 mol % to about 80 mol %, about 60 mol % to about 75 mol %, or about 60 mol % to 70 mol % SiO₂ based on the total moles of the glass.

The glass composition of the waste glass may also include Al₂O₃, which may be included to provide stabilization to the glass network and also to provide improved mechanical properties and chemical durability to the glass. In embodiments, the glass compositions of the waste glass may comprise from about 2 mol % to about 30 mol % Al₂O₃, based on the total moles of the glass or glass ceramic compositions. In embodiments, glass compositions of the waste glass may comprise from about 2 mol % to about 25 mol %, from about 2 mol % to about 20 mol %, from about 2 mol % to about 10 mol %, from about 2 mol % to about 5 mol %, from about 5 mol % to about 30 mol %, from about 5 mol % to about 25 mol %, from about 5 mol % to about 20 mol %, from about 5 mol % to about 10 mol %, from about 10 mol % to about 30 mol %, from about 10 mol % to about 25 mol %, from about 10 mol % to about 20 mol %, or from about 20 mol % to about 30 mol % Al₂O₃, based on the total moles of the glass compositions of the waste glass.

In embodiments, the glass compositions of the waste glass comprise lithium oxide. The glass compositions of the waste glass may comprise from about 2 to about 20 mol % Li₂O, based on the total moles of the glass compositions. In embodiments, the glass compositions of the waste glass may comprise from about 2 mol % to about 15 mol %, from about 2 mol % to about 10 mol %, from about 2 mol % to about 5 mol %, from about 5 mol % to about 20 mol %, from about 5 mol % to about 15 mol %, from about 5 mol % to about 10 mol %, from about 10 mol % to about 20 mol %, or from about 10 mol % to about 15 mol % Li₂O, based on the total moles of the glass compositions.

In embodiments, the glass compositions of the waste glass can include boron. In embodiments, the glass compositions of the waste glass can include boron trioxide (B₂O₃). B₂O₃ may reduce a melt temperature of the glass and/or viscosity of the glass. In embodiments, the glass compositions of the waste glass include may include from 0 mol % to about 20 mol % B₂O₃ based on the total moles of the glass compositions. In embodiments, the glass compositions of the waste glass may include from 0 mol % to about 15 mol %, from 0 mol % to about 10 mol %, from 0 mol % to about 5 mol %, from 0 mol % to about 2 mol %, from about 2 mol % to about 20 mol %, from about 2 mol % to about 15 mol %, from about 2 mol % to about 10 mol %, from about 2 mol % to about 5 mol %, from about 5 mol % to about 20 mol %, from about 5 mol % to about 15 mol %, from about 5 mol % to about 10 mol %, from about 10 mol % to about 20 mol %, or from about 10 mol % to about 15 mol % B₂O₃ based on the total moles of the glass compositions of the waste glass.

In embodiments, the glass compositions of the waste glass can include non-lithium alkali metal oxides, such as Na₂O, K₂O, or both. Na₂O and K₂O are well-known in glass chemistry as “fluxes”, which refer to constituents that reduce the viscosity of glass and may be present in many types of glass. In contrast, alumina (Al₂O₃) and zirconia (ZrO₂) tend to increase the viscosity of glass. In embodiments, the glass compositions of the waste glass may comprise from 0 mol % to about 40 mol %, from 0 mol % to about 30 mol %, from 0 mol % to about 25 mol %, from 0 mol % to about 20 mol %, from about 0 mol % to about 10 mol %, from about 1 mol % to about 40 mol %, from about 1 mol % to about 30 mol %, from about 1 mol % to about 25 mol %, from about 1 mol % to about 20 mol %, from about 1 mol % to about 10 mol %, from about 5 mol % to about 40 mol %, from about 5 mol % to about 30 mol %, from about 5 mol % to about 25 mol %, from about 5 mol % to about 20 mol %, from about 5 mol % to about 15 mol %, or from about 5 mol % to about 10 mol % non-lithium alkali metal oxides, based on the total moles of the glass compositions, where the non-lithium alkali metal oxides comprise Na₂O, K₂O, or both.

In embodiments, the glass compositions of the waste glass may comprise Na₂O. In embodiments, the glass compositions of the waste glass may comprise from 0 mol % to about 20 mol % Na₂O based on the total moles of the glass compositions. In embodiments, the glass compositions of the waste glass may comprise from 0 mol % to about 15 mol %, from 0 mol % to about 10 mol %, from 0 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % Na₂O, based on the total moles of the glass compositions in the waste glass. In embodiments, the glass compositions of the waste glass may comprise K₂O. In embodiments, the glass compositions of the waste glass may comprise from 0 mol % to about 20 mol % K₂O based on the total moles of the glass compositions. In embodiments, the glass compositions of the waste glass may comprise from 0 mol % to about 15 mol %, from 0 mol % to about 10 mol %, from 0 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % K₂O, based on the total moles of the glass compositions in the waste glass.

In addition to non-lithium alkali metal oxides, alkaline earth metal oxides may also be present in the glass compositions of the waste glass. Alkaline earth metal oxides can include CaO, MgO, SrO, BaO, or combinations of these. In embodiments, the glass compositions of the waste glass may have from 0 mol % (zero mol %) to about 30 mol % total RO based on the total moles of the glass compositions, where RO comprises CaO, MgO, SrO, BaO, or combinations of these. In embodiments, the glass compositions of the waste glass may comprise from 0 mol % to about 25 mol %, from 0 mol % to about 20 mol %, from 0 mol % to about 15 mol %, from 0 mol % to about 10 mol %, from about 0.5 mol % to about 30 mol %, from about 0.5 mol % to about 25 mol %, from about 0.5 mol % to about 20 mol %, from about 0.5 mol % to about 15 mol %, from about 0.5 mol % to about 10 mol %, from about 5 mol % to about 30 mol %, from about 5 mol % to about 25 mol %, from about 5 mol % to about 20 mol %, from about 5 mol % to about 10 mol %, from about 10 mol % to about 30 mol %, from about 10 mol % to about 25 mol %, or from about 10 mol % to about 20 mol % total RO, based on the total moles of the glass compositions in the waste glass.

In embodiments, the glass compositions of the waste glass may comprise MgO. In embodiments, the glass compositions may comprise from 0 mol % to about 20 mol %, from 0 mol % to about 15 mol %, from 0 mol % to about 10 mol %, from 0 mol % to about 5 mol %, from about 0.1 mol % to about 20 mol %, from about 0.1 mol % to about 15 mol %, from about 0.1 mol % to about 10 mol %, from about 0.1 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % MgO, based on the total moles of the glass compositions.

In embodiments, the glass compositions of the waste glass may comprise CaO. In embodiments, the glass compositions may comprise from 0 mol % to about 20 mol %, from 0 mol % to about 15 mol %, from 0 mol % to about 10 mol %, from 0 mol % to about 5 mol %, from about 0.1 mol % to about 20 mol %, from about 0.1 mol % to about 15 mol %, from about 0.1 mol % to about 10 mol %, from about 0.1 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % CaO, based on the total moles of the glass compositions.

In embodiments, the glass compositions of the waste glass may comprise SrO. In embodiments, the glass compositions may comprise from 0 mol % to about 10 mol %, from 0 mol % to about 8 mol %, from 0 mol % to about 5 mol %, from 0 mol % to about 2 mol %, from about 0.1 mol % to about 10 mol %, from about 0.1 mol % to about 8 mol %, from about 0.1 mol % to about 5 mol %, from about 0.1 mol % to about 2 mol %, from about 1 mol % to about 10 mol %, from about 1 mol % to about 8 mol %, from about 1 mol % to about 5 mol %, from about 2 mol % to about 10 mol %, from about 2 mol % to about 8 mol %, from about 2 mol % to about 5 mol %, or from about 5 mol % to about 10 mol % SrO, based on the total moles of the glass compositions.

In embodiments, the glass compositions of the waste glass may comprise BaO. In embodiments, the glass compositions may comprise from 0 mol % to about 10 mol %, from 0 mol % to about 8 mol %, from 0 mol % to about 5 mol %, from 0 mol % to about 2 mol %, from about 0.1 mol % to about 10 mol %, from about 0.1 mol % to about 8 mol %, from about 0.1 mol % to about 5 mol %, from about 0.1 mol % to about 2 mol %, from about 1 mol % to about 10 mol %, from about 1 mol % to about 8 mol %, from about 1 mol % to about 5 mol %, from about 2 mol % to about 10 mol %, from about 2 mol % to about 8 mol %, from about 2 mol % to about 5 mol %, or from about 5 mol % to about 10 mol % BaO, based on the total moles of the glass compositions

In glass and glass-ceramic compositions, it is generally found that ZrO₂ can improve the stability of Li₂O—Al₂O₃—SiO₂ glass by significantly reducing glass devitrification during forming and lowering the liquidus temperature. At concentrations above 8 wt %, ZrSiO₄ can form a primary liquidus phase at a high temperature, which significantly lowers liquidus viscosity. Transparent glasses can be formed when the glass contains over 2 wt % ZrO₂. In embodiments, the glass compositions of the waste glass may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % ZrO₂, based on the total moles of the glass compositions of the waste glass.

In embodiments, the glass compositions of the waste glass may include one or more other glass constituents, such as but not limited to of Fe₂O₃, SnO₂, HfO₂, TiO₂, P₂O₅, Co₃O₄, Cr₂O₃, CuO, ZnO, NiO, Sb₂O₃, or combinations of these. In embodiments the glass compositions of the waste glass may include TiO₂. In embodiments, the glass compositions of the waste glass may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % TiO₂ based on the total moles of the glass compositions. In embodiments the glass compositions of the waste glass may include SnO₂. In embodiments, the glass compositions of the waste glass may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % SnO₂ based on the total moles of the glass compositions.

### EXAMPLES

The embodiments of the methods of the present disclosure for recovering lithium from waste glass, glass ceramics, or both will be further clarified by the following examples.

### Examples 1-4: Acid Leaching and Effect of Acid Concentration

In Examples 1-4, waste glass was acid leached to remove lithium from the waste glass, and the concentration of the acid in the leaching solution was changed to investigate the effects of acid concentration on the extraction efficiency. Waste glass having the composition in Table 1 was provided. The waste glass contained a small concentration of organic contamination, which precludes directly re-melting the glass back in a glass making process. The Li₂O content in the waste glass was 4.96 wt. %, which is close to the lithium content of low-grade spodumene concentrate and higher than that of most of the lepidolite concentrate. The waste glass for Examples 1-4 was 100% amorphous glass and had a crystallinity of zero percent.

TABLE 1
Concentration of Waste Glass for the Examples

| Oxide | wt % | mol % |
|---|---|---|
| SiO₂ | 54.69 | 58.43 |
| Al₂O₃ | 28.31 | 17.82 |
| B₂O₃ | 6.63 | 6.11 |
| CaO | 0.503 | 0.58 |
| MgO | 2.77 | 4.41 |
| Li₂O | 4.96 | 10.65 |
| Na₂O | 1.67 | 1.73 |
| K₂O | 0.267 | 0.18 |
| SnO₂ | 0.198 | 0.08 |

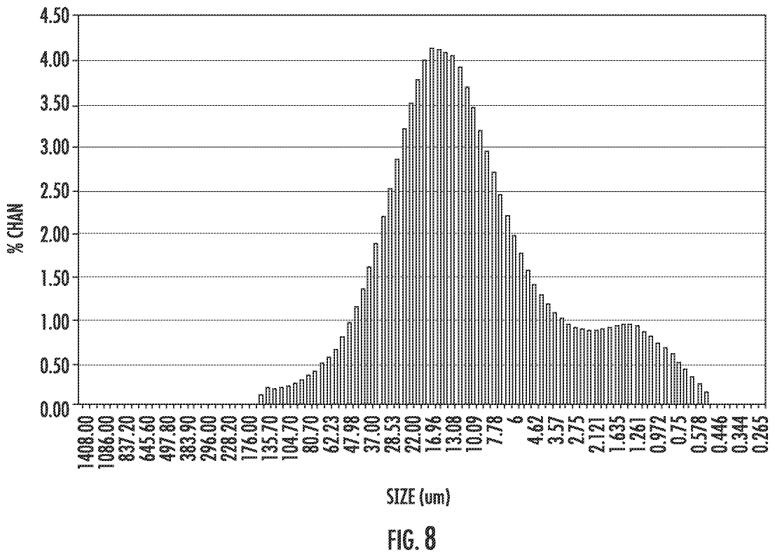

The waste glass was first crushed to reduce the waste glass to a plurality of waste glass particles. Referring now to FIG. 8, the particle size distribution of the waste glass particles after crushing is graphically provided. The waste glass particles had a d10 of 1.9 μm, a d50 of 12 μm, and a d90 of 33.7 μm. For Examples 1-4, from 50 grams to 150 grams of the waste glass particles were leached with a leaching solution at 95° C. in a Teflon beaker with a condenser on top and magnetic stirring inside the leaching solution. The total weight of the leaching solution was 500 grams, and the liquid to solids ratio during the leaching was 10:1 on a weight basis. The leaching solution comprised H₂SO₄ in water. For Examples 1-4, the concentration of H₂SO₄ was 1 wt. % for Example 1, 5 wt. % for Example 2, 10 wt. % for Example 3, and 20 wt. % for Example 4. The leaching was conducted for different contact times ranging from 1 hour to 24 hours for each of Examples 1-4. After leaching for each contact time, the residual solids were filtered from the leaching solution using in a Buchner funnel with filtering papers of different pore sizes. A 0.45 μm bottle-top filter was used as the last step to remove the very fine suspended particles from the leaching solution. Samples were then taken for IC and ICP for the measurement of lithium and other components in the solution. The extraction efficiency was determined from the IC and ICP measurements of the lithium content of the solution and mass balance calculations with the incoming waste glass. The extraction efficiency refers to the percentage of lithium removed from the waste glass.

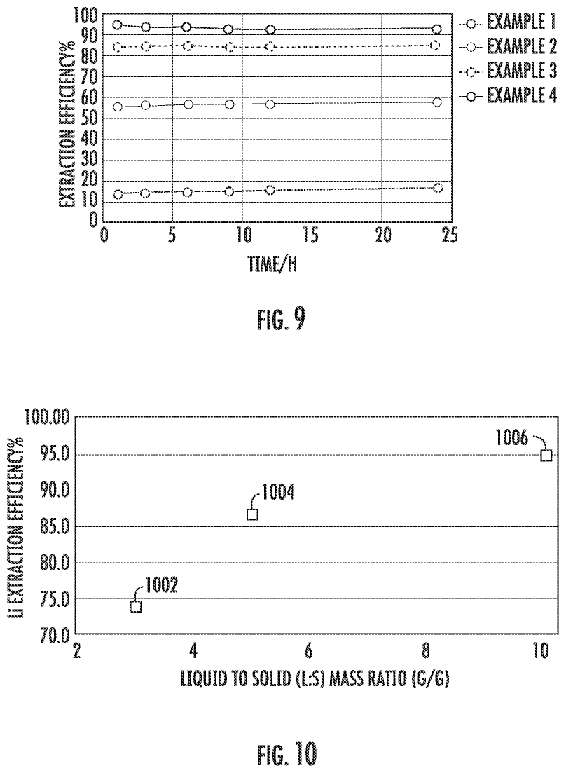

Referring now to FIG. 9, the extraction efficiency as a function of time for each of Examples 1-4 is graphically depicted. As shown in FIG. 9, when the concentration of the H₂SO₄ is from 10 wt. % to 20 wt. %, the leaching process with an acid leaching solution can result in a lithium extraction efficiency of from 85% to 95%. When the acid concentration is less than 10 wt. %, the lithium extraction efficiency drops to less than 60% at 5 wt. % H₂SO₄. Thus, a concentration of acid in the leaching solution of from 10 wt. % to 20 wt. % provides for good extraction efficiency.

### Examples 5-7: Acid Leaching and Effects of Changing L:S Ratio

In Examples 5-7, the waste glass was acid leached with at different liquid to solid (L:S) ratio to investigate the effects of L:S ratio on the extraction efficiency. For Examples 5-7, the waste glass had the composition in Table 1 and was 100% amorphous glass with a crystallinity of zero percent. The waste glass was crushed to provide waste glass particles characterized by the particle size distribution shown in FIG. 8. The waste glass particles were then leached with a leaching solution at 95° C. in a Teflon beaker with a condenser on top and magnetic stirring inside the leaching solution. The leaching solution comprised H₂SO₄ in water. The total weight of the leaching solution was 500 grams, and the concentration of H₂SO₄ in the leaching solution was 20 wt. % based on the total weight of the leaching solution. For Examples 5-7, the L:S ratio was varied from 3:1 for Example 5, to 5:1 for Example 6, to 10:1 for Example 7, by weight. After leaching for a contact period of 1 hour, the residual solids were filtered from the leaching solution using in a Buchner funnel with filtering papers of different pore sizes. A 0.45 μm bottle-top filter was used as the last step to remove the very fine suspended particles from the leaching solution. Samples were then taken for IC and ICP for the measurement of lithium and other components in the solution. The extraction efficiency was determined from the IC and ICP measurements of the lithium content of the solution and mass balance calculations with the incoming waste glass.

Referring now to FIG. 10, the Li extraction efficiency as a function of L:S ratio for each of Examples 5-7 is graphically depicted. As shown in FIG. 10, after 1 hour, the L:S ratio of 10:1 of Example 7 (ref. no. 1006) resulted in an Li extraction efficiency of 95%. Even at a L:S ratio of 5:1, as in Example 6 (ref. no. 1004), an Li extraction efficiency of 85% after 1 hour was achieved. However, at an L:S ratio of 3:1 or less, as in Example 5 (ref. no. 1002), the Li extraction efficiency drops to less than 75% after 1 hour. Thus, an L:S ratio of greater than 5:1 can produce a high Li extraction efficiency in a short amount of time. At L:S ratio less than 3:1, a good Li extraction efficiency of 75% can be achieved after one hour, however, additional time may be needed to increase the Li extraction efficiency to greater than 85% when the L:S ratio is 3:1 or less.

### Examples 8-10: Acid Leaching and Effects of Leaching Temperature

In Examples 8-10, the waste glass was acid leached at different temperatures to investigate the effect of temperature on the Li extraction efficiency of the acid leaching process. For Examples 8-10, the waste glass had the composition in Table 1 and was 100% amorphous glass with a crystallinity of zero percent. The waste glass was crushed to provide waste glass particles characterized by the particle size distribution shown in FIG. 8. The waste glass particles were then leached with a leaching solution in a Teflon beaker with a condenser on top and magnetic stirring inside the leaching solution. The leaching solution comprised H₂SO₄ in water. The total weight of the leaching solution was 500 grams, the concentration of H₂SO₄ in the leaching solution was 10 wt. % based on the total weight of the leaching solution, and the L:S ratio was 3:1 by weight. For Examples 8-10, the temperature was varied from 25° C. for Example 8, to 55° C. for Example 9, and to 95° C. for Example 10. After leaching for a contact period of 1 hour, the residual solids were filtered from the leaching solution using in a Buchner funnel with filtering papers of different pore sizes. A 0.45 μm bottle-top filter was used as the last step to remove the very fine suspended particles from the leaching solution. Samples were then taken for IC and ICP for the measurement of lithium and other components in the solution. The extraction efficiency was determined from the IC and ICP measurements of the lithium content of the solution and mass balance calculations with the incoming waste glass.

Referring now to FIG. 11, the Li extraction efficiency as a function of temperature for Examples 8-10 is graphically depicted. As shown in FIG. 11, increasing the temperature increases the Li extraction efficiency of the acid leaching after 1 hour. The greatest Li extraction efficiency was achieved at a temperature of 95° C., at which temperature, the Li extraction efficiency was about 63% after 1 hour with a leaching solution comprising 10 wt. % H₂SO₄ and an L:S ratio of 3:1. The Li extraction efficiency was much less at temperatures of 55° C. and 25° C.

### Example 11: Acid Leaching and Separation

In Example 11, the waste glass of Table 1 was acid leached and then various constituents of the leachate were removed through separation processes before precipitating the lithium from the leachate. For Example 11, the waste glass had the composition in Table 1 and was 100% amorphous glass with a crystallinity of zero percent. The waste glass was crushed to provide waste glass particles characterized by the particle size distribution shown in FIG. 8. The waste glass particles were then leached with a leaching solution in a Teflon beaker with a condenser on top and magnetic stirring inside the leaching solution. The leaching solution comprised H₂SO₄ in water. The total weight of the acid leaching solution was 500 grams, the concentration of H₂SO₄ in the acid leaching solution was 10 wt. % based on the total weight of the acid leaching solution before addition of the glass particles, and the L:S ratio was 10:1 by weight. The acid leaching of Example 11 was conducted at 95° C. for a total contact time of 3 hours. After leaching for a contact period of 1 hour, the residual solids were filtered from the leaching solution using in a Buchner funnel with filtering papers of different pore sizes. A 0.45 μm bottle-top filter was used as the last step to remove the very fine suspended particles from the leaching solution. Samples were then taken for IC and ICP for the measurement of lithium and other components in the solution. The extraction efficiency was determined from the IC and ICP measurements of the lithium content of the solution and mass balance calculations with the incoming waste glass. The concentration of various species extracted from the waste glass in the leachate and the extraction efficiency for each of the extracted species are provided in Table 2.

TABLE 2
Concentration and Extraction Efficiencies
for Extracted Species in Leachate.

| Extracted | Concentration in | Leaching |
|---|---|---|
| Element | Leachate (ppmw) | Efficiency (%) |
| Aluminum (Al) | 11000 | 74 |
| Boron (B) | 1520 | 74 |
| Calcium (Ca) | 210 | 59 |
| Potassium (K) | 152 | 69 |
| Lithium (Li) | 1950 | 85 |
| Magnesium (Mg) | 1330 | 80 |
| Sodium (Na) | 870 | 71 |
| Silicon (Si) | 115 | <1 |

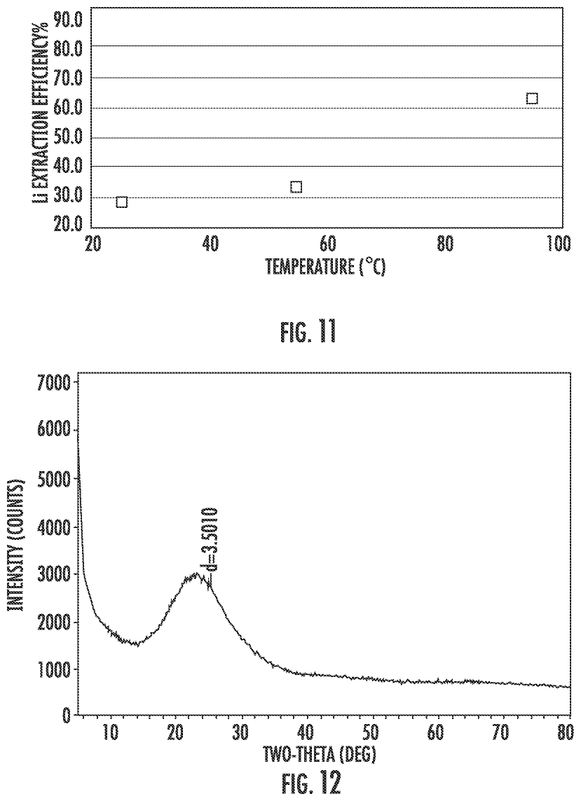

As shown in Table 2, acid leaching extracts a number of species from the waste glass particles, but does not appear to extract much of the silicon species (e.g., silica) from the waste glass particles. Referring to FIG. 12, the XRD plot for the residual solids removed from the leachate shows a single peak at 2-theta of about 22, which is indicative of the silica remaining in the residual solids after acid leaching. As shown in Table 2, several species are extracted and may be present in the leachate. These species, specifically Al, Ca, and Mg, can co-precipitate with the lithium during lithium separation, which results in contamination of the lithium recovered from the process. Therefore, the leachate of Example 11 was further treated to separate out the aluminum in a first separation and to separate out Ca and Mg in a second separation prior to precipitating the lithium out of the leachate.

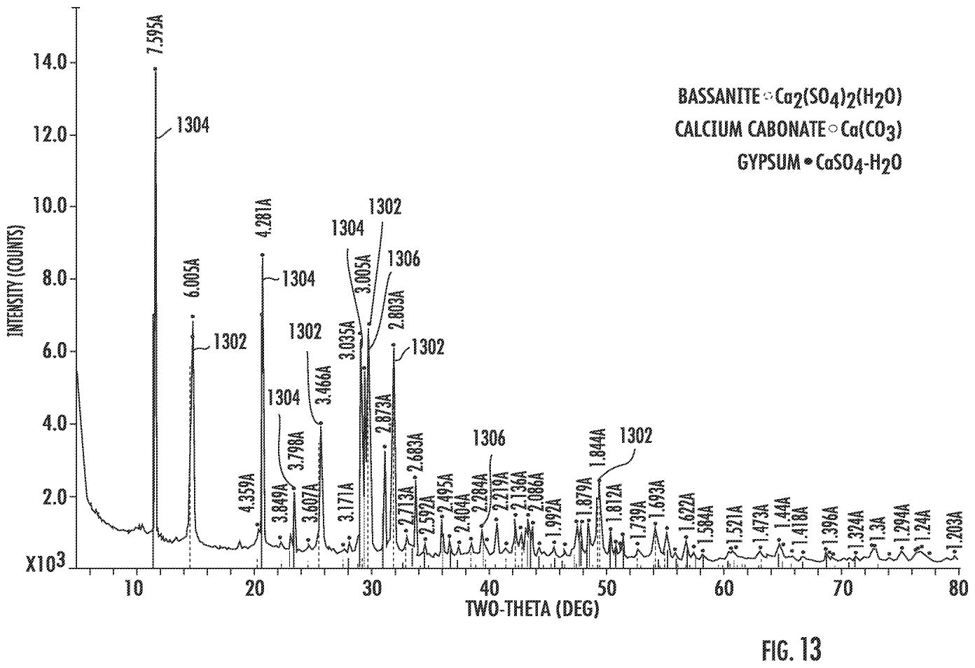

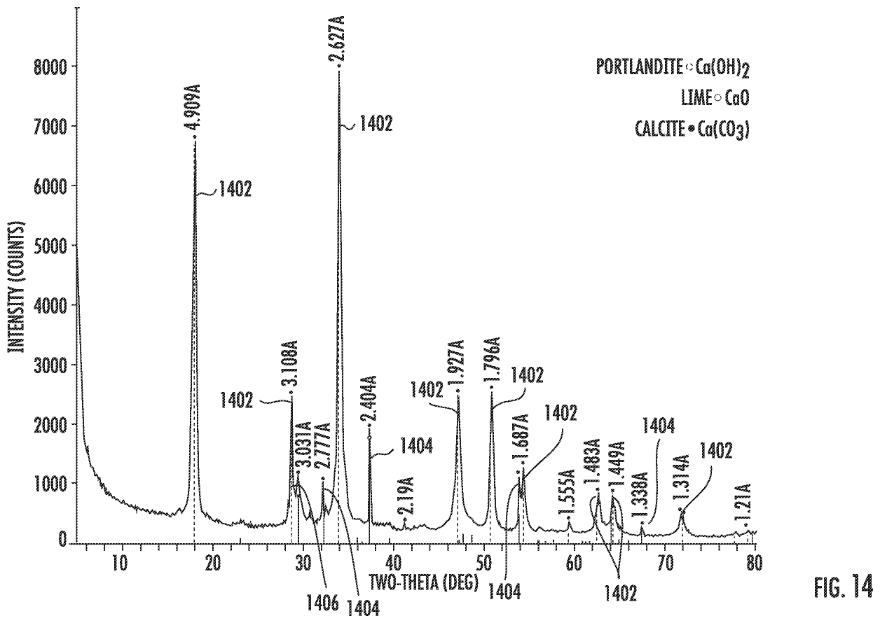

In Example 11, the leachate, which was a clear solution, was neutralized using CaCO₃ powders or a 30 wt. % NaOH solution to a pH of 6.5 under constant agitation of the solution to remove aluminum (Al) species to produce a first filtrate. The residue was then separated with a vacuum filter. When the neutralization reagent was CaCO₃ powder, the neutralization caused aluminum hydroxide (Al(OH)₃) and various calcium species, such as gypsum (CaSO₄·2H₂O), basanite (Ca₂(SO₄)₂(H₂O)), and unreacted CaCO₃, to precipitate. Referring now to FIG. 13, the XRD plot for the solids produced using CaCO₃ powders shows peaks 1302 characteristic of basanite, peaks 1304 indicative of gypsum, and peaks 1306 indicative of unreacted CaCO₃. In the case of using NaOH as the neutralizing reagent, amorphous Al(OH)₃ of high purity can be obtained, which can be reused directly in glass making or as raw materials in the aluminum industry.

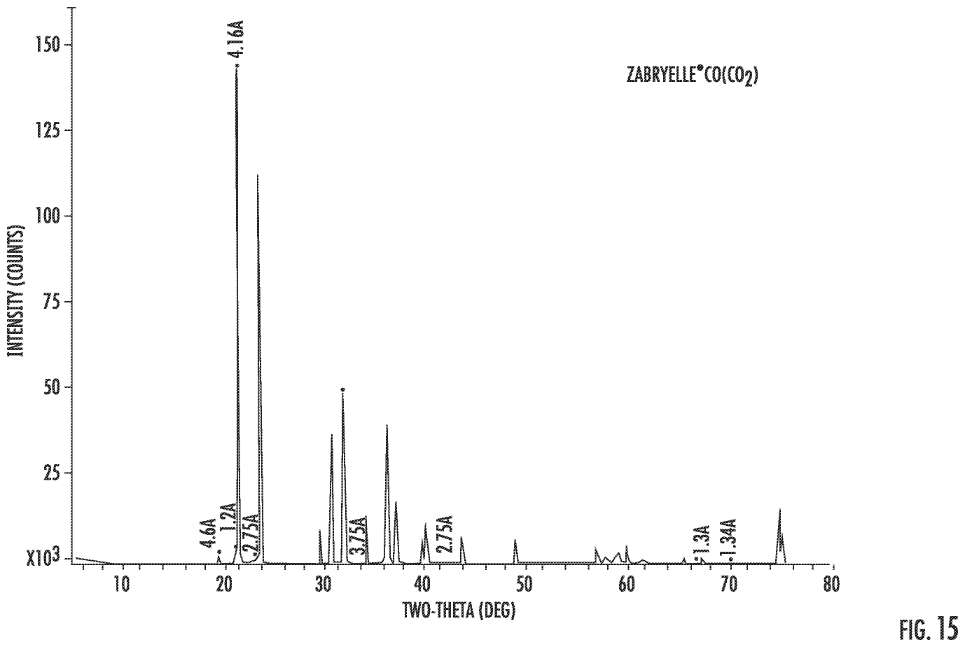

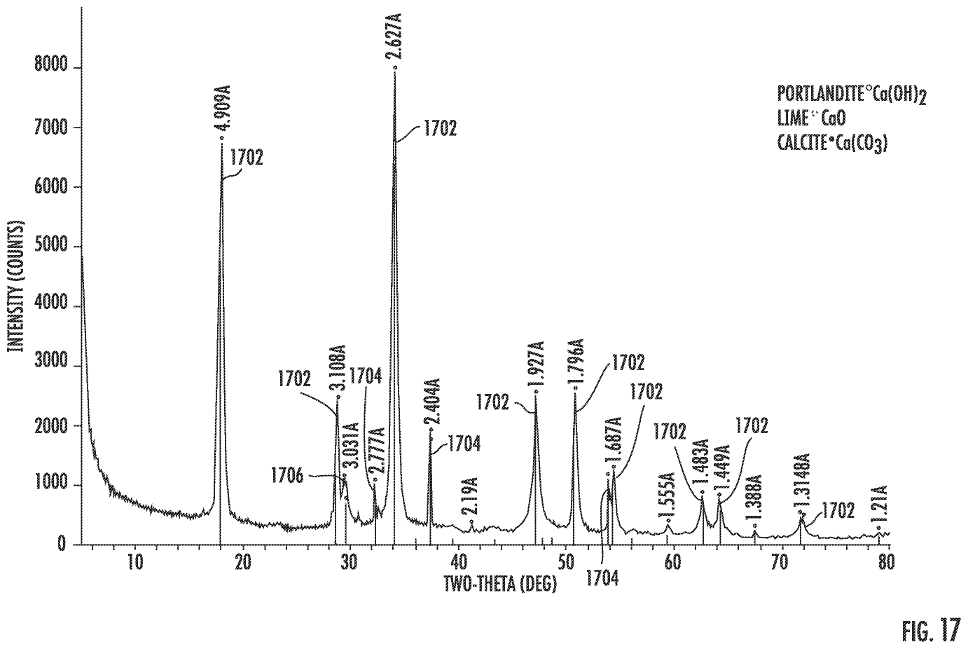

Following neutralization to remove aluminum species, the first filtrate was then adjusted to a pH of 12.3 using CaO powders or 30 wt. % NaOH solution to precipitate and remove Ca and Mg species from the first filtrate to produce a second filtrate. The solids obtained from increasing the pH to 12.3 were recovered through vacuum filtration, and the solids were analyzed using XRD. Referring now to FIG. 14, when the pH adjusting reagent is CaO, the solids obtained were found to include portlandite (Ca(OH)₂), as indicate by peaks 1402; unreacted lime (CaO), as indicated by peaks 1404; and calcite (Ca(CO₃)), as indicated by peaks 1406. Referring now to FIG. 17, when the pH adjusting reagent is the 30 wt. % NaOH solution, the solids obtained were found to also include portlandite (Ca(OH)₂), as indicate by peaks 1702; lime (CaO), as indicated by peaks 1704; and calcite (Ca(CO₃)), as indicated by peaks 1706.

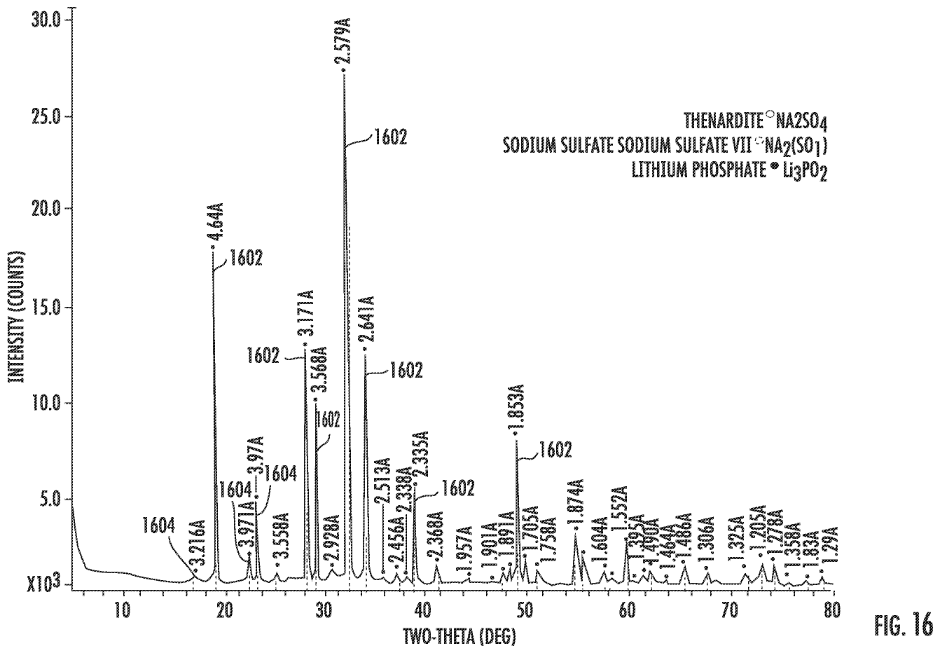

Following the pH adjustment and removal of the resulting solids, the second filtrate was then treated with a lithium precipitating agent to precipitate lithium from the second filtrate. The lithium precipitating agents used included Na₂CO₃ and Na₃PO₄ powders. When Na₂CO₃ was used as the lithium precipitating agent, the precipitated solids included Li₂(CO₃), which is shown in the XRD plot in FIG. 15. Referring now to FIG. 16, when Na₃PO₄ was used as the lithium precipitating agent, the precipitated solids included sodium sulfate (Na₂SO₄) (both anhydrous and sodium sulfate (VI), as shown by peaks 1602 in FIG. 15; and lithium phosphate (Li₃PO₄), as shown by peaks 1604 in FIG. 16.

### Example 12: Base Leaching Process

In Example 12, waste glass was leached with a base to remove lithium from the waste glass. Waste glass having the composition in Table 3 was provided. The Li₂O content in the waste glass was 4.44 wt. %, which is close to the lithium content of low-grade spodumene concentrate and higher than that of most of the lepidolite concentrate.

TABLE 3
Concentration of Waste Glass for Example 12

| Constituent | wt % |
|---|---|
| SiO₂ | 56.92 |
| Al₂O₃ | 24.83 |
| As₂O₃ | 0.0002 |
| B₂O₃ | 6.550 |
| BaO | 0.0018 |
| CaO | 3.76 |
| Co₃O₄ | 0.0114 |
| Cr₂O₃ | 0.0677 |
| CuO | 0.2924 |
| Fe₂O₃ | 0.0180 |
| K₂O | 0.29 |
| Li₂O | 4.44 |
| MgO | 1.259 |
| Na₂O | 1.515 |
| NiO | 0.01 |
| Sb₂O₃ | 0.0012 |
| SnO₂ | 0.01 |
| SrO | 0.0062 |
| TiO₂ | 0.0128 |
| ZnO | 0.0008 |
| ZrO₂ | 0.008 |

The waste glass was first crushed to reduce the waste glass to a plurality of waste glass particles. Referring again to FIG. 8, the particle size distribution of the waste glass particles after crushing is graphically provided. The waste glass particles had a d10 of 1.9 μm, a d50 of 12 μm, and a d90 of 33.7 μm. For Example 12, from 50 grams of the waste glass particles were leached with a base leaching solution at 95° C. in a Teflon beaker with a condenser on top and magnetic stirring inside the leaching solution. The total weight of the base leaching solution was 500 grams, and the liquid to solids ratio during the leaching was 10:1 on a weight basis. The base leaching solution comprised 20 wt. % NaOH in water based on the total weight of the leaching solution prior to adding the waste glass particles. The leaching was conducted for a contact time of about 3 hours.

After base leaching for 3 hours, the residual solids were filtered from the base leaching solution using in a Buchner funnel with filtering papers of different pore sizes. A 0.45 μm bottle-top filter was used as the last step to remove the very fine suspended particles from the base leaching solution. Samples were then taken for IC and ICP for the measurement of lithium and other components in the leachate. The lithium extraction efficiency was determined from the IC and ICP measurements of the lithium content of the solution and mass balance calculations with the incoming waste glass. The extraction efficiency refers to the percentage of lithium removed from the waste glass. The extraction efficiency for the base leaching process of Example 12 was about 92%. Further, the concentration of silicon in the leachate after the base leaching was about 11,400 ppm.

### Example 13: Base Leaching Process

In Example 13, CaO was added to the base leaching solution of Example 12 to reduce the extraction of silicon from the waste glass particles. For Example 13, the glass composition in Table 3 was first crushed to produce a waste glass particles having a d10 of 1.9 μm, a d50 of 12 μm, and a d90 of 33.7 μm. For Example 13, from 50 grams were subjected to base leaching as described in Example 12, except that the base leaching solution further included 20 grams of CaO. For Example 13, the extraction efficiency for lithium was about 90%. However, the concentration of silicon in the base leachate was reduced to 880 ppm, which was less than 10% of the silicon in the base leachate of Example 12. Example 13 demonstrates that the concentration of silicon in the leachate can be reduced by including lime (CaO) in the base leaching solution.

### Example 14: Base Leaching of Chemically Durable Glass

In Example 14, a waste glass having a high chemical durability was leached with a base to remove lithium from the waste glass. Waste glass having the composition in Table 4 was provided. The glass in Table 4 had a high chemical durability, meaning that the glass exhibits less than 2% weight loss when exposed to 5 wt. % NaOH solution for a period of 24 hours. The Li₂O content in the waste glass was 11.2 wt %. The waste glass of Example 14 had a high crystallinity of 86%. The crystalline phases included petalite (47 wt. %), lithium disilicate (38 wt. %), and cristobalite (0.6 wt. %), with the balance being amorphous glass.

TABLE 4
Concentration of Waste Glass for Example 14

| Constituent | wt % |
|---|---|
| SiO₂ | 74.35 |
| Al₂O₃ | 7.56 |
| P₂O₅ | 2.09 |
| Na₂O | 0.05 |
| K₂O | 0.12 |
| Li₂O | 11.2 |
| ZrO₂ | 4.31 |
| Fe₂O₃ | 0.06 |
| HfO₂ | 0.08 |
| SnO₂ | 0.02 |

The waste glass was first crushed to reduce the waste glass to a plurality of waste glass particles. The waste glass particles had a d10 of 1.9 μm, a d50 of 12 μm, and a d90 of 33.7 μm. For Example 14, from 50 grams of the waste glass particles were leached with a base leaching solution at 95° C. in a Teflon beaker with a condenser on top and magnetic stirring inside the leaching solution. The total weight of the base leaching solution was 500 grams, and the liquid to solids ratio during the leaching was 10:1 on a weight basis. The base leaching solution comprised 20 wt. % NaOH and 8 wt. % CaO in water based on the total weight of the leaching solution prior to adding the waste glass particles. The leaching was conducted for a contact time of about 5 hours.

After base leaching for 5 hours, the residual solids were filtered from the base leaching solution using in a Buchner funnel with filtering papers of different pore sizes. A 0.45 μm bottle-top filter was used as the last step to remove the very fine suspended particles from the base leaching solution. Samples were then taken for IC and ICP for the measurement of lithium and other components in the leachate. The lithium extraction efficiency was determined from the IC and ICP measurements of the lithium content of the solution and mass balance calculations with the incoming waste glass. The extraction efficiency refers to the percentage of lithium removed from the waste glass. The extraction efficiency for the base leaching process of Example 14 was about 70%. Example 14 demonstrates that the base leaching process can be suitable for recovering lithium from high chemical durability glass at high extraction rates.

While embodiments and examples have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

What is claimed is:

1. A method of extracting lithium from glass, the method comprising:
crushing the glass to produce glass particles, wherein the glass comprises lithium;
contacting the glass particles with an aqueous leaching solution at a leaching temperature greater than ambient temperature and less than the boiling temperature of the aqueous leaching solution to produce a leachate slurry, wherein:
the aqueous leaching solution comprising sulfuric acid in water or sodium hydroxide in water; and
contacting the glass particles with the aqueous leaching solution leaches greater than or equal to about 50% of the lithium out of the glass particles;
separating the leachate slurry to produce a solid residue and a leachate, the leachate comprising the lithium leached from the glass particles; and
recovering the lithium from the leachate.

2. The method of claim 1, wherein the aqueous leaching solution comprises sulfuric acid (H₂SO₄) in water.

3. The method of claim 2, wherein the aqueous leaching solution comprises from about 1 wt. % to about 90 wt. % H₂SO₄ based on the total weight of the aqueous leaching solution before contacting the glass particles with the aqueous leaching solution.

4. The method of claim 1, wherein the aqueous leaching solution comprises from about 10 wt. % to about 70 wt. % of a base, wherein the base is selected from sodium hydroxide (NaOH), potassium hydroxide (KOH), or combinations thereof.

5. The method of claim 4, wherein the aqueous leaching solution further comprises from about 5 wt. % to about 20 wt. % calcium oxide (CaO) based on the total weight of the aqueous leaching solution.

6. The method of claim 4, wherein the aqueous leaching solution comprises from about 10 wt. % to about 70 wt. % sodium hydroxide based on the total weight of the aqueous leaching solution before contacting the glass particles with the aqueous leaching solution.

7. The method of claim 1, wherein the leaching temperature is from about 55° C. to about 95° C.

8. The method of claim 1, comprising contacting the glass particles with the aqueous leaching solution at a weight ratio of liquid to solid of greater than or equal to about 3.

9. The method of claim 1, wherein the glass of the glass particles comprises:
from about 30 mol % to about 85 mol % SiO₂;
from about 2 mol % to about 30 mol % Al₂O₃;
from 0 mol % to about 20 mol % B₂O₃;
from about 2 mol % to about 20 mol % Li₂O;
from 0 mol % to about 20 mol % Na₂O;
from 0 mol % to about 20 mol % K₂O;
from 0 mol % to about 20 mol % MgO;
from 0 mol % to about 20 mol % CaO;
from 0 mol % to about 10 mol % SrO;
from 0 mol % to about 10 mol % BaO;
from 0 mol % to about 5 mol % ZrO₂;
from 0 mol % to about 5 mol % Ti₂O; and
from 0 mol % to about 5 mol % Sn₂O.

10. The method of claim 1, wherein the glass particles comprise an amorphous structure having less than or equal to about 1 wt. % crystallized structure based on the total weight of the glass.

11. The method of claim 1, wherein the glass particles have an average particle size of from about 2 micrometers (μm) to about 1 mm.

12. The method of claim 1, wherein the method has an extraction efficiency of greater than or equal to about 70% for extracting lithium from the glass particles.

13. The method of claim 1, wherein the solid residue has a lithium content that is less than or equal to about 30% of a lithium content of the glass particles prior to contacting with the aqueous leaching solution.

14. The method of claim 1, wherein recovering the lithium from the leachate comprises:
precipitating one or more lithium salts from the leachate; and
filtering the lithium salts from the leachate.

15. The method of claim 14, wherein precipitating the one or more lithium salts from the leachate comprises contacting the leachate with a precipitating agent comprising sodium carbonate, sodium phosphate, or both, wherein the precipitating agent reacts with the lithium in the leachate to produce the one or more lithium salts.

16. The method of claim 15, wherein the precipitating agent comprises sodium phosphate and the lithium salts comprise lithium phosphate, lithium sodium phosphate, or combinations thereof.

17. The method of claim 15, wherein:
the precipitating agent comprises sodium carbonate;
the one or more lithium salts comprises lithium carbonate; and
precipitating the one or more lithium salts from the leachate further comprises:
evaporating water from the leachate until a concentration of lithium in the leachate is greater than or equal to about 20 g/L; and
after evaporating the water, contacting the leachate with the sodium carbonate.

18. The method of claim 14, wherein recovering the lithium from the leachate further comprises:
removing aluminum from the leachate;
after removing the aluminum from the leachate, precipitating the one or more lithium salts from the leachate; and
separating the one or more lithium salts from the leachate to produce a lithium depleted filtrate and the one or more lithium salts.

19. The method of claim 18, wherein removing aluminum from the leachate comprises:
precipitating one or more aluminum compounds from the leachate; and
filtering the one or more aluminum compounds from the leachate to produce a reduced aluminum filtrate.

20. The method of claim 18, wherein the aqueous leaching solution is an acid leaching solution and removing aluminum from the leachate comprises:
contacting the leachate with a sulfate reagent, wherein the sulfate reagent reacts with the at least a portion of the aluminum in the leachate to produce alum;
crystallizing the alum in the leachate; and
separating the alum from the leachate to produce a reduced aluminum filtrate and alum solids.
